(19) United States
(12) Patent Application Publication
(10) Pub. No.: US 2026/0087986 A1
(43) Pub. Date: Mar. 26, 2026

(54) GATE DRIVER, DISPLAY DEVICE INCLUDING THE GATE DRIVER AND ELECTRONIC DEVICE INCLUDING THE DISPLAY DEVICE

(71) Applicant: Samsung Display Co., LTD., Yongin-si (KR)

(72) Inventors: MINJAE JEONG, Yongin-si (KR); ILNAM KIM, Yongin-si (KR); MINKYU WOO, Yongin-si (KR); JAEYONG JANG, Yongin-si (KR); JAEHYUNG CHO, Yongin-si (KR)

(21) Appl. No.: 19/237,772

(22) Filed: Jun. 13, 2025

(30) Foreign Application Priority Data
Sep. 25, 2024 (KR) 10-2024-0129783

(51) Int. Cl. G09G 3/3233

(52) U.S. Cl. CPC G09G 3/3233; G09G 2300/0426; G09G 2300/0852; G09G 2300/0861; G09G 2310/08; G09G 2330/021

(57) ABSTRACT

A gate driver includes an input circuit which transmits an input signal to a first control node based on a clock signal, a control circuit which transmits a first power supply voltage to a third control node based on the input signal, and transmits the first power supply voltage to a second control node based on the first power supply voltage and a voltage of the third control node, a first output circuit which outputs a gate signal having second or third power supply voltage based on voltages of the first control node and the second control node, and a second output circuit which outputs a carry signal having the third or first power supply voltage based on the voltage of the second control node, where the carry signal has a phase opposite to a phase of the gate signal.

This application claims priority to Korean Patent Application No. 10-2024-0129783, filed on Sep. 25, 2024, and all the benefits accruing therefrom under 35 U.S.C. § 119, the content of which in its entirety is herein incorporated by reference.

### BACKGROUND

### 1. Field

Embodiments of the invention relate to a gate driver, a display device including the gate driver, and an electronic device including the display device.

### 2. Description of the Related Art

Generally, a display device may include a display panel and a display panel driver. The display panel may include gate lines, emission lines, data lines, and pixels. The display panel driver may include a gate driver for providing gate signals to the gate lines, an emission driver for providing emission signals to the emission lines, a data driver for providing data voltages to the data lines, and a driving controller for controlling the gate driver, the emission driver, and the data driver.

### SUMMARY

In a display device, as transistors included in a gate driver thereof are degraded, the characteristics of the transistors may be varied. As the characteristics of the transistors are varied, a level of an output signal of the gate driver may become unstable.

An embodiment of the invention provides a gate driver with high stability and high reliability.

Another embodiment the invention provides a display device including the gate driver.

Still another embodiment of the invention provides an electronic device including the display device.

However, embodiments of the present disclosure are not limited to those described herein, and may be variously extended without departing from the spirit and scope of the present disclosure.

According to embodiments, a gate driver includes an input circuit which transmits an input signal to a first control node based on a clock signal, a control circuit which transmits a first power supply voltage to a third control node based on the input signal, and transmits the first power supply voltage to a second control node based on the first power supply voltage and a voltage of the third control node, a first output circuit which outputs a gate signal having a second power supply voltage or a third power supply voltage based on a voltage of the first control node and a voltage of the second control node, and a second output circuit which outputs a carry signal having the third power supply voltage or the first power supply voltage based on the voltage of the second control node, where the carry signal has a phase opposite to a phase of the gate signal.

In an embodiment, the input circuit may include a first transistor including a control electrode which receives the clock signal, a first electrode which receives the input signal, and a second electrode connected to the first control node.

In an embodiment, the control circuit may include a second transistor including a control electrode which receives the first power supply voltage, a first electrode connected to the third control node, and a second electrode connected to the second control node and a third transistor includes a control electrode which receives the input signal, a first electrode connected to the third control node, and a second electrode which receives the first power supply voltage.

In an embodiment, the control circuit may further include a fourth transistor including a control electrode connected to the first control node, a first electrode which receives the third power supply voltage, and a second electrode connected to the third control node and a second capacitor including a first electrode which receives the third power supply voltage and a second electrode connected to the first control node.

In an embodiment, the first output circuit may include a fifth transistor including a control electrode connected to the first control node, a first electrode which receives the third power supply voltage, and a second electrode connected to a first output node, a sixth transistor including a control electrode connected to the second control node, a first electrode connected to the first output node, a second electrode which receives the second power supply voltage, and a first capacitor including a first electrode connected to the second control node and a second electrode connected to the first output node.

In an embodiment, the second output circuit may include a seventh transistor including a control electrode connected to the second control node, a first electrode which receives the third power supply voltage, and a second electrode connected to a second output node and an eighth transistor including a control electrode connected to the second control node, a first electrode connected to the second output node, and a second electrode which receives the first power supply voltage.

In an embodiment, the third transistor and the eighth transistor may be N-type transistors.

In an embodiment, the first transistor, the second transistor and the fourth to seventh transistors may be P-type transistors.

In an embodiment, the third transistor further may include a second control electrode which receives a fourth power supply voltage.

In an embodiment, a level of the fourth power supply voltage may be lower than a level of the first power supply voltage.

In an embodiment, the eighth transistor further may include a second control electrode connected to the control electrode of the eighth transistor.

In an embodiment, a level of the first power supply voltage may be lower than a level of the second power supply voltage, and a level of the third power supply voltage may be higher than the level of the second power supply voltage.

In an embodiment, a level of the first power supply voltage may be higher than a level of the second power supply voltage, and a level of the third power supply voltage may be higher than the level of the first power supply voltage.

According to embodiments, a display device includes a display panel including a pixel, a gate driver which outputs a gate signal to the pixel, a data driver which outputs a data voltage to the pixel, and a driving controller which control the gate driver and the data driver. In such embodiments, the gate driver includes an input circuit which transmits an input signal to a first control node based on a clock signal, a control circuit which transmits a first power supply voltage to a third control node based on the input signal, and transmits the first power supply voltage to a second control node based on the first power supply voltage and a voltage of the third control node, a first output circuit which outputs the gate signal having a second power supply voltage or a third power supply voltage based on a voltage of the first control node and a voltage of the second control node, and a second output circuit which outputs a carry signal having the third power supply voltage or the first power supply voltage based on the voltage of the second control node, where the carry signal has a phase opposite to a phase of the gate signal.

In an embodiment, the input circuit may include a first transistor including a control electrode which receive the clock signal, a first electrode which receives the input signal, and a second electrode connected to the first control node.

In an embodiment, the control circuit may include a second transistor includes a control electrode which receives the first power supply voltage, a first electrode connected to the third control node, and a second electrode connected to the second control node and a third transistor includes a control electrode which receives the input signal, a first electrode connected to the third control node, and a second electrode which receive the first power supply voltage.

In an embodiment, the control circuit may further include a fourth transistor including a control electrode connected to the first control node, a first electrode which receives the third power supply voltage, and a second electrode connected to the third control node and a second capacitor including a first electrode which receives the third power supply voltage and a second electrode connected to the first control node.

In an embodiment, the first output circuit may include a fifth transistor including a control electrode connected to the first control node, a first electrode which receives the third power supply voltage, and a second electrode connected to a first output node, a sixth transistor including a control electrode connected to the second control node, a first electrode connected to the first output node, a second electrode which receives the second power supply voltage, and a first capacitor including a first electrode connected to the second control node and a second electrode connected to the first output node.

In an embodiment, the second output circuit may include a seventh transistor including a control electrode connected to the second control node, a first electrode which receives the third power supply voltage, and a second electrode connected to a second output node and an eighth transistor including a control electrode connected to the second control node, a first electrode connected to the second output node, and a second electrode which receives the first power supply voltage.

According to embodiments, an electronic device includes a processor which outputs an input control signal and input image data, a display panel including a pixel, a gate driver which outputs a gate signal to the pixel, a data driver which outputs a data voltage to the pixel, and a driving controller which controls the gate driver and the data driver based on the input control signal and the input image data. In such embodiments, the gate driver includes an input circuit which transmits an input signal to a first control node based on a clock signal, a control circuit which transmits a first power supply voltage to a third control node based on the input signal, and transmits the first power supply voltage to a second control node based on the first power supply voltage and a voltage of the third control node, a first output circuit which outputs the gate signal having a second power supply voltage or a third power supply voltage based on a voltage of the first control node and a voltage of the second control node, and a second output circuit which outputs a carry signal having the third power supply voltage or the first power supply voltage based on the voltage of the second control node, wherein the carry signal has a phase opposite to a phase of the gate signal.

In embodiments, the gate driver may include the first to eighth transistors. In such embodiments, the third transistor and the eighth transistor may be implemented as the N-type transistors and the first transistor, the second transistor, the fourth to seventh transistors may be implemented as the P-type transistors.

In such embodiments, the first transistor, the second transistor, the fourth to seventh transistors are implemented as the P-type transistors, such that driving currents of the first transistor, the second transistor, the fourth to seventh transistors may be increased. Accordingly, a stability and a reliability of the gate driver may be improved.

In such embodiments, the third transistor and the eighth transistor are implemented as the N-type transistors, such that a leakage current of the eighth transistor may be decreased. Accordingly, the stability and the reliability of the gate driver may be increased. In addition, power consumption of the display device may be decreased.

In an embodiment, a first power supply voltage and a second power supply voltage may be less than about zero 0 volt (V) and the third power supply voltage may be greater than about zero (0) V. The level of the first power supply voltage may be lower than the level of the second power supply voltage.

When the first power supply voltage is applied to a second electrode of the third transistor and the third power supply voltage is applied to the control electrode of the third transistor, a difference between a voltage of the control electrode of the third transistor and a voltage of the second electrode of the third transistor is greater than a threshold voltage of the third transistor. Accordingly, the third transistor may be turned on, the third transistor may transmit the first power supply voltage to a third control node. Accordingly, the third control node may maintain the level of the first power supply voltage and the stability and the reliability of the gate driver may be improved.

When the first power supply voltage is applied to the second electrode of the third transistor and the first power supply voltage is applied to the control electrode of the third transistor, the third transistor may be turned off. Accordingly, a leakage current of the third transistor may be decreased and a voltage of the third control node may stably maintain the level of the first power supply voltage or the level of the third power supply voltage. Accordingly, the stability and the reliability of the gate driver may be improved. In addition, as the leakage current of the third transistor is decreased, the power consumption of the display device may be decreased.

When the voltage of the second control node has a level of the boosting voltage, a difference between a voltage of a control electrode of the sixth transistor and a voltage of a first electrode of the sixth transistor may be increased. Accordingly, even when a threshold voltage of the sixth transistor is varied, the difference between the voltage of the control electrode of the sixth transistor and the voltage of the first electrode of the sixth transistor may be greater than the threshold voltage of the sixth transistor. That is, the sixth transistor may be turned on. Accordingly, the sixth transistor may stably transmit the second power supply voltage to a first output node and a first stage may stably output a first gate signal having the level of the second power supply voltage. Accordingly, the stability and the reliability of the gate driver may be improved.

When the voltage of the second control node has the third power supply voltage, a difference between a voltage of control electrode of the eighth transistor and a voltage of a second electrode of the eighth transistor may be greater than a threshold voltage of the eighth transistor. Accordingly, the eighth transistor may be turned on and the eighth transistor may transmit the first power supply voltage to the first output node. Accordingly, the first stage may stably output a first carry signal having the level of the first power supply voltage and the stability and the reliability of the gate driver may be improved.

When the voltage of the second control node has a level of a boosting voltage, the eighth transistor may be turned off. Accordingly, a leakage current of the eighth transistor may be decreased and the first stage may stably output the first gate signal having the level of the third power supply voltage. Accordingly, the stability and the reliability of the gate driver may be improved. In addition, as the leakage current of the eighth transistor is decreased, the power consumption of the display device may be decreased.

In an embodiment, the first power supply voltage and the second power supply voltage may be less than about zero (0) V and the third power supply voltage may be greater than about zero (0) V. The level of the first power supply voltage may be higher than the level of the second power supply voltage. In such an embodiment where the level of the first power supply voltage is higher than the level of the second power supply voltage, the power consumption of the display device may be decreased.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a block diagram illustrating an embodiment of a gate driver included in the display device of FIG. 1.

FIG. 3 is a circuit diagram illustrating an embodiment of a stage included in the gate driver of FIG. 2.

FIG. 4 is a signal timing diagram illustrating an operation of the stage of FIG. 3.

FIG. 5 is a circuit diagram illustrating an operation of the stage of FIG. 3 in a first period.

FIG. 6 is a circuit diagram illustrating an operation of the stage of FIG. 3 in a second period.

FIG. 7 is a circuit diagram illustrating an operation of the stage of FIG. 3 in a third period.

FIG. 8 is a circuit diagram illustrating an operation of the stage of FIG. 3 in a fourth period.

FIG. 9 is a circuit diagram illustrating an embodiment of a pixel included in a display panel included in the display device of FIG. 1.

FIG. 10 is a circuit diagram illustrating another embodiment of a stage included in the gate driver of FIG. 2.

FIG. 11 is a block diagram illustrating another embodiment of a gate driver included in the display device of FIG. 1.

FIG. 12 is a circuit diagram illustrating an embodiment of a stage included in the gate driver of FIG. 11.

FIG. 13 is a circuit diagram illustrating another embodiment of a stage included in the gate driver of FIG. 11.

FIG. 14 is a circuit diagram illustrating another embodiment of a stage included in the gate driver of FIG. 11.

FIG. 15 is a circuit diagram illustrating another embodiment of a stage included in the gate driver of FIG. 11.

FIG. 16 is a block diagram illustrating an electronic device according to embodiments.

FIG. 17 is a diagram illustrating an embodiment in which the electronic device of FIG. 16 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, display devices in accordance with embodiments will be described in more detail with reference to the accompanying drawings. The same reference numerals are used for the same components in the drawings, and any repetitive detailed descriptions of the same components will be omitted or simplified.

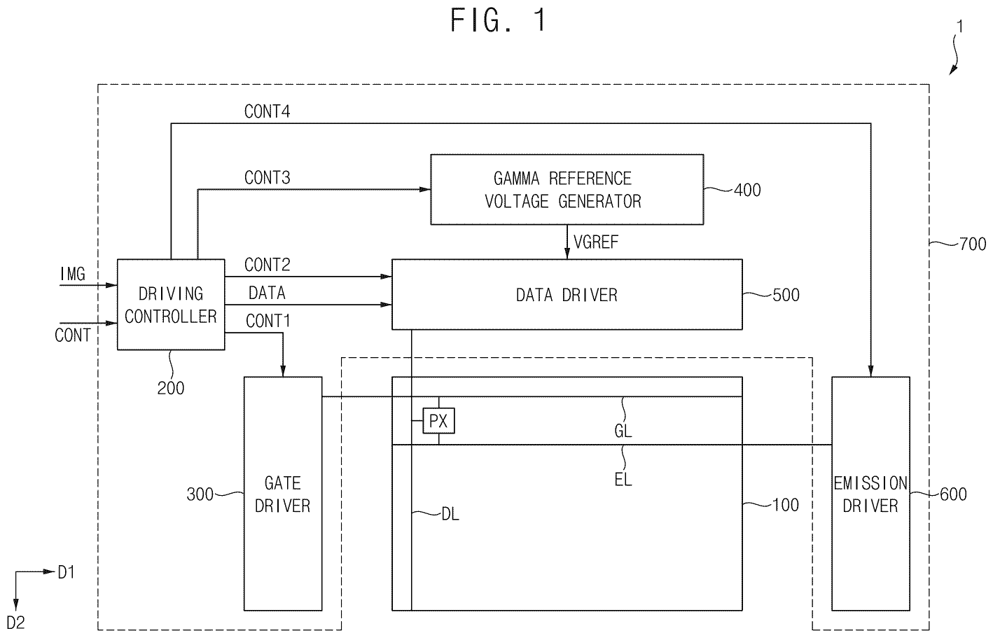

FIG. 1 is a block diagram illustrating a display device 1 according to embodiments.

Referring to FIG. 1, an embodiment of the display device 1 may include a display panel 100 and display panel driver 700. The display panel driver 700 may include a driving controller 200, a gate driver 300, a gamma reference voltage generator 400, a data driver 500, and an emission driver 600.

The display panel 100 may have a display region, on which an image is displayed, and a peripheral region adjacent to the display region.

The display panel 100 may include gate lines GL, data lines DL, emission lines EL and pixels PX electrically connected to the gate lines GL, the data lines DL, and the emission lines EL. The gate lines GL may extend in a first direction D1, the data lines DL may extend in a second direction D2 crossing the first direction D1, and the emission lines EL may extend in the first direction D1.

The driving controller 200 may receive input image data IMG and an input control signal CONT from an external processor. In an embodiment, for example, the input image data IMG may include red image data, green image data and blue image data. In some embodiments, the input image data IMG may further include white image data. In another embodiment, for example, the input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input control signal CONT and the input image data IMG.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The gate driver 300 may generate gate signals transmitted to the pixels PX through the gate lines GL in response to the first control signal CONT1 received from the driving controller 200. The gate driver 300 may output the gate signals to the gate lines GL. For example, the gate signals may include a writing gate signal, a compensation gate signal, and an initialization gate signal.

In an embodiment, the gate driver 300 may be integrated on the peripheral region of the display panel 100. In an embodiment, the gate driver 300 may be mounted on the peripheral region of the display panel 100.

The gamma reference voltage generator 400 may generate a gamma reference voltage VGREF in response to the third control signal CONT3 received from the driving controller 200. The gamma reference voltage generator 400 may output the gamma reference voltage VGREF to the data driver 500. The gamma reference voltage VGREF may have a value corresponding to the data signal DATA

In an embodiment, the gamma reference voltage generator 400 may be disposed or included in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

In an embodiment, the data driver 500 may be integrated on the peripheral region of the display panel 100. In an embodiment, the data driver 500 may be mounted on the peripheral region of the display panel 100.

The emission driver 600 may generate emission signals transmitted to the pixels PX through the emission lines EL in response to the fourth control signal CONT4 received from the driving controller 200. The emission driver 600 may output the emission signals to the emission lines EL.

In an embodiment, the emission driver 600 may be integrated on the peripheral region of the display panel 100. In an embodiment, the emission driver 600 may be mounted on the peripheral region of the display panel 100.

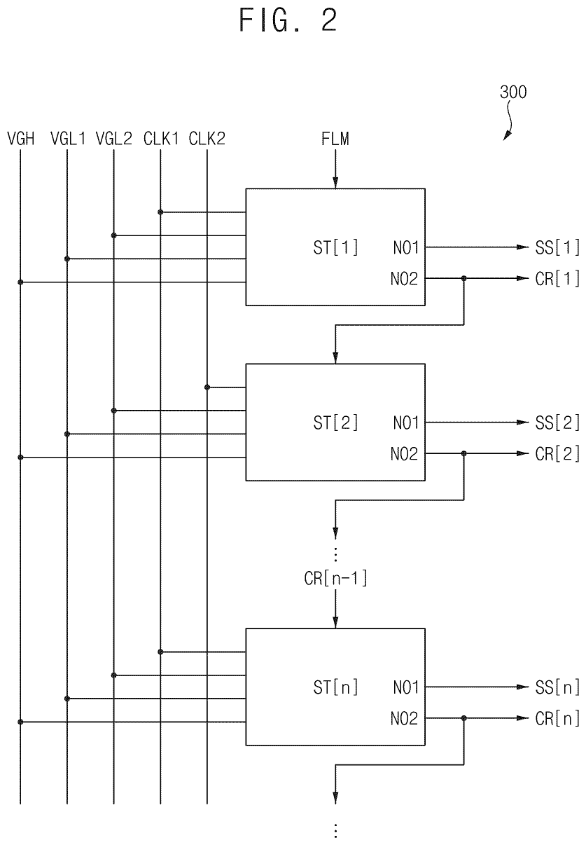

FIG. 2 is a block diagram illustrating an embodiment of the gate driver 300 included in the display device 1 of FIG. 1.

Referring to FIG. 2, an embodiment of the gate driver 300 may include stages. In an embodiment, for example, the gate driver 300 may include a first stage ST[1] and a second stage ST[2]. In addition, the gate driver 300 may include a n-th stage ST[n].

Each of the stages may receive a first power supply voltage VGL1, a second power supply voltage VGL2, and a third power supply voltage VGH. In an embodiment, for example, the first power supply voltage VGL1 and the second power supply voltage VGL2 may less than about zero (0) volt (V), and the third power supply voltage VGH may greater than about 0 V. In an embodiment, for example, a level of the first power supply voltage VGL1 may be lower than a level of the second power supply voltage VGL2. In an embodiment, for example, the level of the first power supply voltage VGL1 may be higher than the level of the second power supply voltage VGL2.

Each of the stages may receive a first clock signal CLK1 or a second clock signal CLK2. In addition, each of the stages may receive an input signal. The input signal may be a start signal FLM or a carry signal CR of a previous stage. In an embodiment, for example, the input signal applied to the first stage ST[1] may be the start signal FLM. The input signal applied to the second stage ST[2] may be a first carry signal CR[1] of the first stage ST[1]. The input signal applied to a third stage ST[3] may be a second carry signal CR[2] of the second stage ST[2]. In this way, the input signal applied to the n-th stage ST[n] may be a (n−1)-th carry signal CR[n−1] of a (n−1)-th stage.

A phase of the first clock signal CLK1 and a phase of the second clock signal CLK2 may be different from each other. In an embodiment, for example, the phase of the first clock signal may be opposite to the phase of the second clock signal CLK2.

Each of the stages may output the gate signal SS and the carry signal CR. A phase of the gate signal SS may be opposite to a phase of the carry signal CR.

The first stage ST[1] may receive the first power supply voltage VGL1, the second power supply voltage VGL2, and the third power supply voltage VGH. In addition, the first stage ST[1] may receive the first clock signal CLK1 and the input signal. The input signal applied to the first stage ST[1] may be the start signal FLM. The first stage ST[1] may output a first gate signal SS[1] and the first carry signal CR[1] based on the first clock signal CLK1 and the start signal FLM.

The second stage ST[2] may receive the first power supply voltage VGL1, the second power supply voltage VGL2, and the third power supply voltage VGH. In addition, the second stage ST[2] may receive the second clock signal CLK2 and the input signal. The input signal applied to the second stage ST[2] may be the first carry signal CR[1] output from the first stage ST[1]. The second stage ST[2] may output a second gate signal SS[2] and the second carry signal CR[2] based on the second clock signal CLK2 and the first carry signal CR[1].

In this way, the n-th stage ST[n] may receive the first power supply voltage VGL1, the second power supply voltage VGL2, and the third power supply voltage VGH. In addition, the n-th stage ST[n] may receive the first clock signal CLK1 and the input signal. The input signal applied to the n-th stage ST[n] may be the (n−1)-th carry signal CR[n−1] output from the (n−1)-th stage ST[n−1]. The n-th stage ST[n] may output a n-th gate signal SS[n] and the n-th carry signal CR[n] based on the first clock signal CLK1 and the (n−1)-th carry signal CR[n−1].

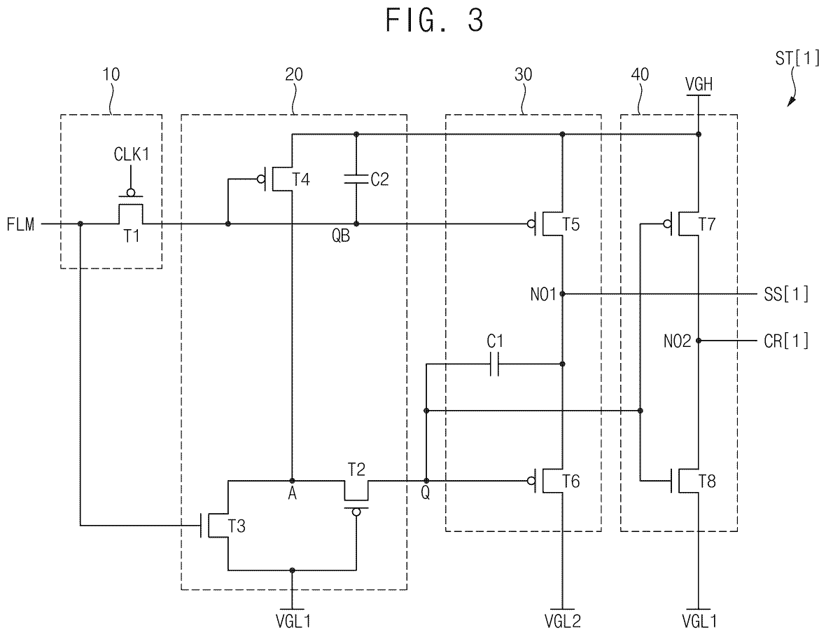

FIG. 3 is a circuit diagram illustrating an embodiment of the stage ST[1] included in the gate driver 300 of FIG. 2.

Referring to FIG. 3, an embodiment of the stage may include an input circuit 10, a control circuit 20, a first output circuit 30, and a second output circuit 40. For convenience of illustration and description, the first stage ST[1] among the stages will hereinafter be mainly described, and any repetitive detailed description of other stages will be omitted.

In an embodiment, the input circuit 10 may include a first transistor T1. The input circuit 10 may transmit the start signal FLM to a first control node QB based on the first clock signal CLK1.

The first transistor T1 may include a control electrode that receives the first clock signal CLK1, a first electrode that receives the start signal FLM, and a second electrode connected to the first control node QB.

In an embodiment, the control circuit 20 may include second to fourth transistors T2 to T4 and a second capacitor C2. The control circuit 20 may control a voltage of the first control node QB and a voltage of the second control node Q based on the start signal FLM.

The second transistor T2 may include a control electrode that receives the first power supply voltage VGL1, a first electrode connected to a third control node A, and a second electrode connected to the second control node Q.

The third transistor T3 may include a control electrode that receives the start signal, a first electrode connected to the third control node A, and a second electrode that receives the first power supply voltage VGL1.

The fourth transistor T4 may include a control electrode connected to the first control node QB, a first electrode that receives the third power supply voltage VGH, and a second electrode connected to the third control node A.

The second capacitor C2 may include a first electrode that receives the third power supply voltage VGH and a second electrode connected to the first control node QB.

In an embodiment, the first output circuit 30 may include a fifth transistor T5, a sixth transistor T6, and a first capacitor C1. The first output circuit 30 may output the first gate signal SS[1] based on the voltage of the first control node QB and the voltage of the second control node Q.

The fifth transistor T5 may include a control electrode connected to the first control node QB, a first electrode that receives the third power supply voltage VGH, and a second electrode connected to a first output node NO1.

The sixth transistor T6 may include a control electrode connected to the second control node Q, a first electrode connected to the first output node NO1, and a second electrode that receives the second power supply voltage VGL2.

The first capacitor C1 may include a first electrode connected to the second control node Q and a second electrode connected to the first output node NO1.

In an embodiment, the second output circuit 40 may include a seventh transistor T7 and an eighth transistor T8. The second output circuit 40 may output the first carry signal CR[1] based on the voltage of the second control node Q.

The seventh transistor T7 may include a control electrode connected to the second control node Q, a first electrode that receives the third power supply voltage VGH, and a second electrode connected to a second output node NO2.

The eighth transistor T8 may include a control electrode connected to the second control node Q, a first electrode connected to the second output node NO2, and a second electrode that receives the first power supply voltage VGL1.

The third transistor T3 and the eighth transistor T8 may be implemented as N-type transistors, and the first transistor T1, the second transistor T2, and the fourth to seventh transistors T4 to T7 may be implemented as P-type transistors. In an embodiment, for example, the third transistor T3 and the eighth transistor T8 may be implemented as N-type metal oxide transistors, and the first transistor T1, and the first transistor T1, the second transistor T2, and the fourth to seventh transistors T4 to T7 may be implemented as P-type low temperature polycrystalline silicon (LTPS) transistors.

In an embodiment, the third transistor T3 and the eighth transistor T8 are implemented as the N-type transistors, such that a leakage current of the third transistor T3 and the eighth transistor T8 may be decreased. Accordingly, a stability and a reliability of the gate driver 300 may be increased. In addition, power consumption of the display device 1 may be decreased.

In an embodiment, the first transistor T1, the second transistor T2, and the fourth to seventh transistors T4 to T7 are implemented as the P-type transistors, such that driving currents of the first transistor T1, the second transistor T2, and the fourth to seventh transistors T4 to T7 may be increased. Accordingly, the stability and the reliability of the gate driver 300 may be increased.

In an embodiment, the first power supply voltage VGL1 and second power supply voltage VGL2 may be less than about zero (0) V, and the third power supply voltage VGH may be greater than about zero (0) V. In addition, the level of the first power supply voltage VGL1 may be lower than the level of the second power supply voltage VGL2.

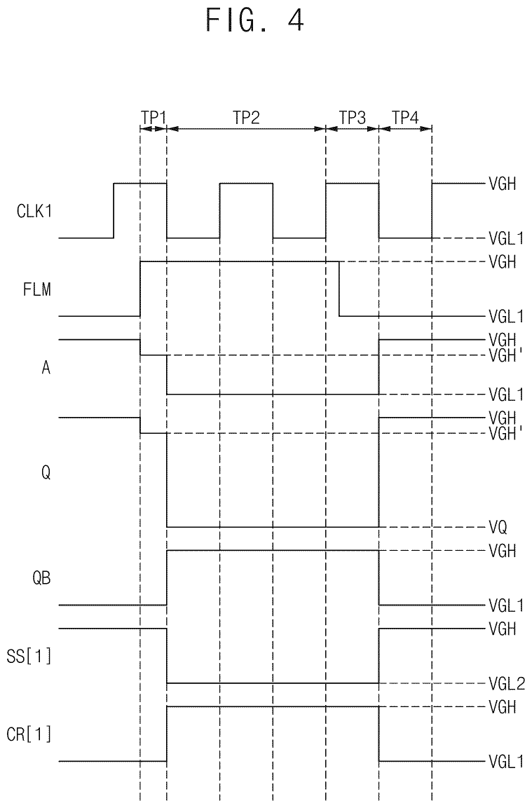

When a level of the first gate signal SS[1] decreases from the level of the third power supply voltage VGH to the level of the second power supply voltage VGL2, the second control node Q may have a boosting voltage VQ. The boosting voltage (VQ in FIG. 4) may be calculated by (or satisfy) the following equation: VQ=VGL1−|Vth_T2|−(VGH-VGL2), where VQ denotes the boosting voltage VQ, VGL1 denotes the first power supply voltage VGL1, Vth_T2 denotes a threshold voltage of the second transistor T2, VGH denotes the third power supply voltage VGH, and VGL2 denotes the second power supply voltage VGL2.

In an embodiment, where the sixth transistor T6 is implemented as the P-type transistor and the voltage of the second control node Q has a level of the boosting voltage VQ, a difference between a voltage of the control electrode of the sixth transistor T6 and a voltage of the first electrode of the sixth transistor T6 may be increased. Accordingly, even when a threshold voltage of the sixth transistor T6 is varied, the difference between the voltage of the control electrode of the sixth transistor T6 and the voltage of the first electrode of the sixth transistor T6 may be greater than the threshold voltage of the sixth transistor T6. That is, the sixth transistor T6 may be turned on. Accordingly, the sixth transistor T6 may be stably transmit the second power supply voltage VGL2 to the first output node NO1, and the first stage ST[1] may stably output the first gate signal SS[1] having the level of the second power supply voltage VGL2. Accordingly, the stability and the reliability of the gate driver 300 may be improved.

In an embodiment, the first power supply voltage VGL1 and the second power supply voltage VGL2 may be less than about zero (0) V, and the third power supply voltage VGH may be greater than about zero (0) V. In addition, the level of the first power supply voltage VGL1 may be higher than the level of the second power supply voltage VGL2.

In such an embodiment, the level of the first power supply voltage VGL1 is higher than the level of the second power supply voltage VGL2, such that the power consumption of the display device 1 may be decreased.

In an embodiment, where the eighth transistor T8 is implemented as the N-type transistor and the voltage of the second control node Q has the level of the third power supply voltage VGH, a difference between a voltage of the control electrode of the eighth transistor T8 and a voltage of the second electrode of the eighth transistor T8 may be increased. The difference between the voltage of the control electrode of the eighth transistor T8 and the voltage of the second electrode of the eighth transistor T8 may greater than a threshold voltage of the eighth transistor T8. Accordingly, the eighth transistor T8 may be turned on and the eighth transistor T8 may transmit the first power supply voltage VGL1 to the first output node NO1. Accordingly, the first stage ST[1] may output the first carry signal CR[1] having the level of the first power supply voltage VGL1 and the stability and the reliability of the gate driver 300 may be improved.

In an embodiment, where the seventh transistor T7 is implemented as the P-type transistor, the eighth transistor T8 is implemented as the N-type transistor, the seventh transistor T7 is turned on, and the voltage of the second control node Q has the level of the boosting voltage VQ, the eighth transistor T8 may be turned off. Accordingly, the leakage current of the eighth transistor T8 may be decreased and the first stage ST[1] may stably output the first gate signal SS[1] having the third power supply voltage VGH. Accordingly, the stability and the reliability of the gate driver 300 may be improved. In addition, as the leakage current of the eighth transistor T8 is decreased, the power consumption of the display device 1 may be decreased.

In an embodiment, where the third transistor T3 is implemented as the N-type transistor, a level of the start signal FLM increases from the level of the first power supply voltage VGL1 to the level of the third power supply voltage VGH, a difference between a voltage of the control electrode of the third transistor T3 and a voltage of the second electrode of the third transistor T3 may be increased. The difference between the voltage of the control electrode of the third transistor T3 and the voltage of the second electrode of the third transistor T3 may be greater than a threshold voltage of the third transistor T3. Accordingly, the third transistor T3 may be turned on, and the third transistor T3 may transmit the first power supply voltage VGL1 to the third control node A. the voltage of the third control node A may stably maintain the level of the first power supply voltage VGL1, and the stability and the reliability of the gate driver 300 may be improved.

In an embodiment, where the third transistor T3 is implemented as the N-type transistor, The start signal FLM has the level of the first power supply voltage VGL1, the third transistor T3 may be turned off. Accordingly, the leakage current of the third transistor T3 may be decreased, and the voltage of the third control node A may stably maintain the level of the first power supply voltage VGL1 or the level of the third power supply voltage VGH. Accordingly, the stability and the reliability of the gate driver 300 may be improved. In addition, as the leakage current of the third transistor T3 is decreased, the power consumption of the display device 1 may be decreased.

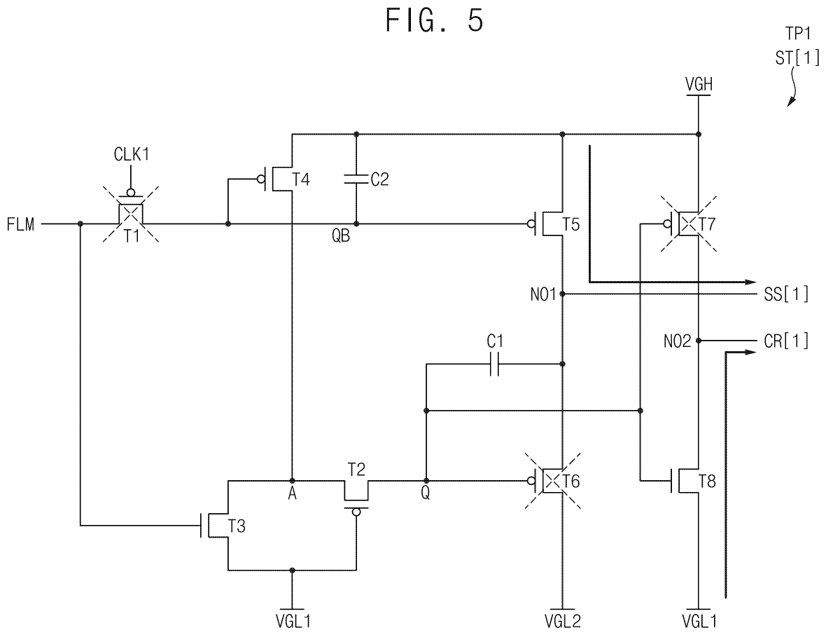

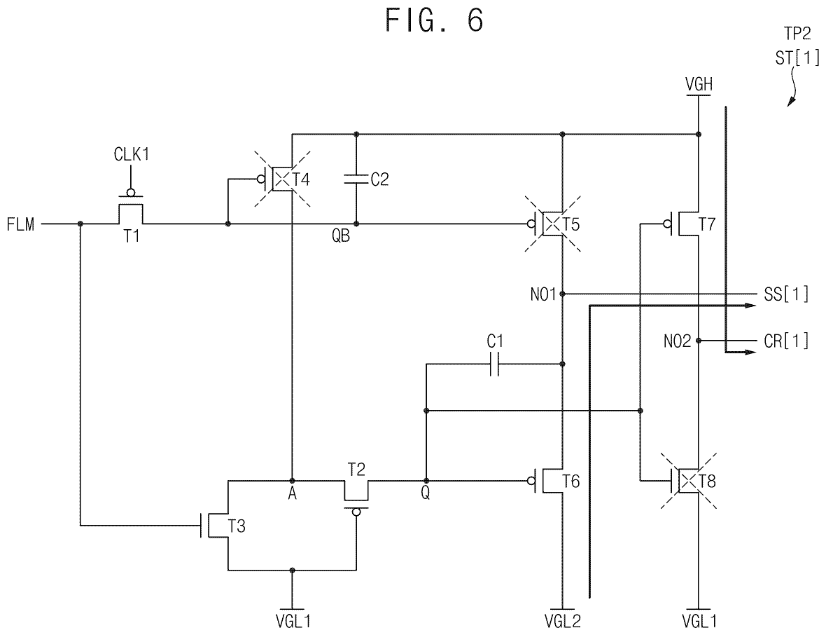

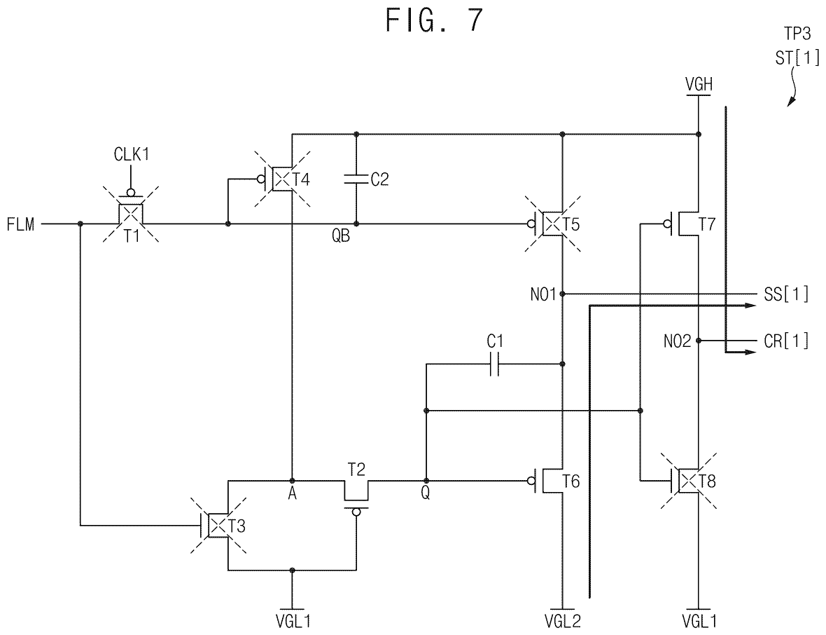

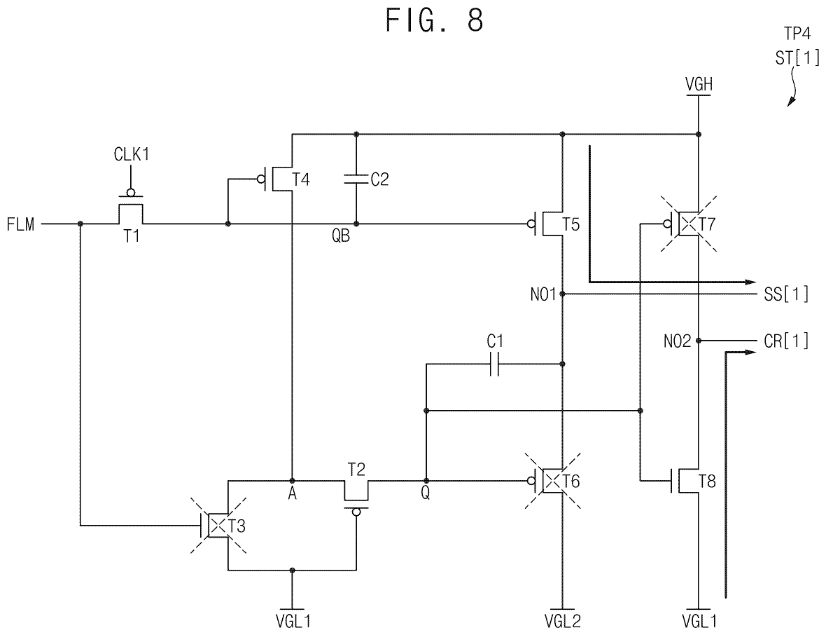

FIG. 4 is a signal timing diagram illustrating an operation of the stage ST[1] of FIG. 3, FIG. 5 is a circuit diagram illustrating an operation of the stage ST[1] of FIG. 3 in a first period TP1, FIG. 6 is a circuit diagram illustrating an operation of the stage ST[1] of FIG. 3 in a second period TP2, FIG. 7 is a circuit diagram illustrating an operation of the stage ST[1] of FIG. 3 in a third period TP3, and FIG. 8 is a circuit diagram illustrating an operation of the stage ST[1] of FIG. 3 in a fourth period TP4.

Referring to FIG. 4, periods where signals is applied to the first stage ST[1] may include the first period TP1, the second period TP2, the third period TP3, and the fourth period TP4.

Referring to FIGS. 4 and 5, the first clock signal CLK1 may have the level of the third power supply voltage VGH in the first period TP1. The start signal may have the level of the third power supply voltage VGH.

The first transistor T1 may be turned off in response to the first clock signal CLK1. Accordingly, the voltage of the first control node QB may maintain the level of the first power supply voltage VGL1. The voltage of the first control node QB may be stably maintained by the second capacitor C2.

The third transistor T3 may be turned on in response to the start signal FLM having the level of the third power supply voltage VGH. The fourth transistor T4 may be turned on in response to the voltage of the first control node QB. The voltage of the third control node A may have a high control voltage VGH′. A level of the high control voltage VGH′ may be lower than the level of the third power supply voltage VGH and may be higher than the level of the first power supply voltage VGL1. The level of the high control voltage VGH′ may be closer to the level of third power supply voltage VGH than the level of the first power supply voltage VGL1.

The second transistor T2 may be turned on by the first power supply voltage VGL1. The second transistor T2 may transmit the voltage of the third control node A to the second control node Q. Accordingly, the voltage of the second control node Q may have the high control voltage VGH′. In addition, the high control voltage VGH′ may be a voltage sufficient (or high enough) to turn off the sixth transistor T6.

The fifth transistor T5 may be turned on in response to the voltage of the first control node QB and the sixth transistor T6 may be turned off in response to the voltage of the second control node Q. The fifth transistor T5 may transmit the third power supply voltage VGH to the first output node NO1 and the voltage of the first output node NO1 may have the level of the third power supply voltage VGH. Accordingly, the first stage ST[1] may output the first gate signal SS[1] having the level of the third power supply voltage VGH.

The seventh transistor T7 may be turned off in response to the voltage of the second control node Q and the eighth transistor T8 may be turned off in response to the voltage of the second control node Q. The eighth transistor T8 may transmit the first power supply voltage VGL1 to the second output node NO2 and the voltage of the second output node NO2 may have the level of the first power supply voltage VGL1. Accordingly, the first stage ST[1] may output the first carry signal CR[1] having the level of the first power supply voltage VGL1.

In an embodiment where the eighth transistor T8 is implemented as the N-type transistor, the difference between the voltage of the control electrode of the eighth transistor T8 and the voltage of the second electrode of the eighth transistor T8 may be increased. The difference between the voltage of the control electrode of the eighth transistor T8 and the voltage of the second electrode of the eighth transistor T8 may be greater than the threshold voltage of the eighth transistor T8. Accordingly, the eighth transistor T8 may be turned on and the first stage ST[1] may stably output the first power supply voltage VGL1 as the first carry signal CR[1]. Accordingly, the stability and the reliability of the gate driver 300 may be improved.

Referring to FIGS. 4 and 6, the first clock signal CLK1 may be toggled between the level of the first power supply voltage VGL1 and the level of the third power supply voltage VGH. The start signal FLM may maintain the level of the third power supply voltage VGH.

When the level of the first clock signal CLK1 is decreased from the level of the third power supply voltage VGH to the level of the first power supply voltage VGL1, the first transistor T1 may be turned on in response to the first clock signal CLK1 having the level of the first power supply voltage VGL1. The first transistor T1 may transmit the start signal FLM to the first control node QB. Accordingly, the voltage of the first control node QB may have the level of the third power supply voltage VGH.

The third transistor T3 may be turned on in response to the start signal FLM. The third transistor T3 may transmit the first power supply voltage VGL1 to the third control node A. Accordingly, the level of the voltage of the third control node A may be decreased from the level of the third power supply voltage VGH to the first power supply voltage VGL1.

In an embodiment where the third transistor T3 is implemented as the N-type transistor, the difference between the voltage of the control electrode of the third transistor T3 and the voltage of the second electrode of the third transistor T3 may be greater than the threshold voltage of the third transistor T3. Accordingly, the third transistor T3 may be turned on and the third transistor T3 may transmit the first power supply voltage VGL1 to the third control node A. The voltage of the third control node A may stably maintain the level of the first power supply voltage VGL1 and the stability and the reliability of the gate driver 300 may be improved.

The second transistor T2 may be turned on in response to the first power supply voltage VGL1. The second transistor T2 may transmit the voltage of the third control node A to the second control node Q. Accordingly, the level of the voltage of the second control node Q may be decreased from the third power supply voltage VGH to the first power supply voltage VGL1.

The fifth transistor T5 may be turned off in response to the voltage of the first control node QB and the sixth transistor T6 may be turned on in response to the voltage of the second control node Q. Accordingly, the sixth transistor T6 may transmit the second power supply voltage VGL2 to the first output node NO1 and the level of the voltage of the first output node NO1 may be decreased from the level of the third power supply voltage VGH to the second power supply voltage VGL2. Accordingly, the first stage ST[1] may output the first gate signal SS[1] having the level of the second power supply voltage VGL2.

When the level of the voltage of the first output node NO1 is decreased from the level of the third power supply voltage VGH to the level of the second power supply voltage VGL2, the voltage of the second control node Q may be bootstrapped by the coupling of the first capacitor C1. Accordingly, the level of the voltage of the second control node Q may be decreased from the level of the first power supply voltage VGL1 to the level of the boosting voltage VQ. The boosting voltage VQ may be calculated by the following equation: VQ=VGL1−|Vth_T2|−(VGH−VGL2), where VQ denotes the boosting voltage VQ, VGL1 denotes the first power supply voltage VGL1, Vth_T2 denotes the threshold voltage of the second transistor T2, VGH denotes the third power supply voltage VGH, and VGL2 denotes the second power supply voltage VGL2.

In an embodiment where the sixth transistor T6 is implemented as the P-type transistor and the level of the voltage of the second control node Q is decreased from the level of the first power supply voltage VGL1 to the level of the boosting voltage VQ, the difference between the voltage of the control electrode of the sixth transistor T6 and the voltage of the first electrode of the sixth transistor T6 may be increased. The difference between the voltage of the control electrode of the sixth transistor T6 and the voltage of the first electrode of the sixth transistor T6 may be greater than the threshold voltage of the sixth transistor T6. Accordingly, the sixth transistor T6 may be turned of and the first stage ST[1] may stably output the second power supply voltage VGL2 as the first gate signal SS[1]. Accordingly, the stability and the reliability of the gate driver 300 may be improved.

The seventh transistor T7 may be turned on in response to the voltage of the second control node Q having the level of the boosting voltage VQ and the eighth transistor T8 may be turned off in response to the voltage of the second control node Q having the level of the boosting voltage VQ. Accordingly, the seventh transistor T7 may transmit the third power supply voltage VGH to the second output node NO2 and the level of the voltage of the second output node NO1 may be increased from the level of the first power supply voltage VGL1 to the level of the third power supply voltage VGH. Accordingly, the first stage ST[1] may output the first carry signal CR[1] having the level of the third power supply voltage VGH. Accordingly, the stability and the reliability of the gate driver 300 may be improved.

In an embodiment where the eighth transistor T8 is implemented as the N-type transistor, the eighth transistor T8 may be turned off and the leakage current of the eighth transistor T8 may be decreased. As the leakage current of the eighth transistor T8 is decreased, the first stage ST[1] may stably output the first carry signal CR[1] having the level of the third power supply voltage VGH. Accordingly, the stability and the reliability of the gate driver 300 may be improved. In addition, as the leakage current of the eighth transistor T8 is decreased, the power consumption of the display device 1 may be decreased.

The level of the first clock signal CLK1 may be increased from the level of the first power supply voltage VGL1 to the level of the third power supply voltage VGH. The start signal FLM may maintain the level of the third power supply voltage VGH.

The first transistor T1 may be turned off in response to the first clock signal CLK1 having the level of the third power supply voltage VGH. The voltage of the first control node QB may maintain the level of the third power supply voltage VGH by the second capacitor C2.

The fourth transistor T4 may be turned off in response to the voltage of the first control node QB and the third transistor T3 may be turned on in response to the start signal FLM. Accordingly, the voltage of the third control node A may maintain the level of the first power supply voltage VGL1. In addition, the voltage of the second control node Q may maintain the level of the boosting voltage VQ.

The fifth transistor T5 may be turned off in response to the voltage of the first control node QB and the sixth transistor T6 may be turned on in response to the voltage of the second control node Q. Accordingly, the sixth transistor T6 may transmit the second power supply voltage VGL2 to the first output node NO1 and the voltage of the first output node NO1 may maintain the level of the second power supply voltage VGL2. Accordingly, the first stage ST[1] may output the second power supply voltage VGL2 as the first gate signal SS[1].

The seventh transistor T7 may be turned on in response to the voltage of the second control node Q and the eighth transistor T8 may be turned off in response to the voltage of the second control node Q. Accordingly, the seventh transistor T7 may transmit the third power supply voltage VGH to the second output node NO2 and the voltage of the second output node NO2 may maintain the level of the third power supply voltage VGH. Accordingly, the first stage ST[1] may output the first carry signal CR[1] having the level of the third power supply voltage VGH.

The level of the first clock signal CLK1 may be decreased from the level of the third power supply voltage VGH to the level of the first power supply voltage VGL1. The start signal FLM may maintain the level of the third power supply voltage VGH.

The first transistor T1 may be turned on in response to the first clock signal CLK1 having the first power supply voltage VGL1. The first transistor T1 may transmit the start signal FLM to the first control node QB. Accordingly, the voltage of the first control node QB may maintain the level of the third power supply voltage VGH.

The fourth transistor T4 may be turned off in response to the voltage of the first control node QB and the third transistor T3 may be turned on in response to the start signal FLM. Accordingly, the voltage of the third control node A may maintain the level of the first power supply voltage VGL1. In addition, the voltage of the second control node Q may maintain the level of the boosting voltage VQ.

The fifth transistor T5 may be turned off in response to the voltage of the first control node QB and the sixth transistor T6 may be turned of in response to the voltage of the second control node Q. Accordingly, the sixth transistor T6 may transmit the second power supply voltage VGL2 to the first output node NO1 and the voltage of the first output node NO1 may maintain the level of the second power supply voltage VGL2. Accordingly, the first stage ST[1] may output the second power supply voltage VGL2 as the first gate signal SS[1].

The seventh transistor T7 may be turned on in response to the voltage of the second control node Q and the eighth transistor T8 may be turned off in response to the voltage of the second control node Q. Accordingly, the seventh transistor T7 may transmit the third power supply voltage VGH to the second output node NO2 and the voltage of the second output node NO2 may maintain the level of the third power supply voltage VGH. Accordingly, the first stage ST[1] may output the first carry signal CR[1] having the level of the third power supply voltage VGH.

Referring to FIGS. 4 and 7, the level of the first clock signal CLK1 may be increased form the level of the first power supply voltage VGL1 to the level of the third power supply voltage VGH in the third period TP3. The level of the start signal FLM may be decreased from the level of the third power supply voltage VGH to the level of the first power supply voltage VGL1.

The first transistor T1 may be turned off in response to the first clock signal CLK1 having the level of the third power supply voltage VGH. The voltage of the first control node QB may be stably maintain the level of the third power supply voltage VGH by the second capacitor C2.

The fourth transistor T4 may be turned off in response to the voltage of the first control node QB.

The third transistor T3 may be turned off in response to the start signal FLM having the level of the first power supply voltage VGL1. Accordingly, the voltage of the third control node A may maintain the level of the first power supply voltage VGL1. In addition, the voltage of the second control node Q may maintain the level of the boosting voltage VQ.

In an embodiment where the third transistor T3 is implemented as the N-type transistor, the third transistor T3 may be turned off. Accordingly, the leakage current of the third transistor T3 may be decreased and the voltage of the third control node A may be stably maintain the level of the first power supply voltage VGL1. Accordingly, the stability and the reliability of the gate driver 300 may be improved. In addition, as the leakage current of the third transistor T3 is decreased, the power consumption of the display device 1 may be decreased.

The fifth transistor T5 may be turned off in response to the voltage of the first control node QB and the sixth transistor T6 may be turned on in response to the voltage of the second control node Q. Accordingly, the sixth transistor T6 may transmit the second power supply voltage VGL2 to the first output node NO1 and the voltage of the first output node NO1 may maintain the level of the second power supply voltage VGL2. Accordingly, the first stage ST[1] may output the second power supply voltage VGL2 as the first gate signal SS[1].

In an embodiment where the sixth transistor T6 is implemented as the P-type transistor and the voltage of the second control node Q has the level of the boosting voltage VQ, the difference between the voltage of the control electrode of the sixth transistor T6 and the voltage of the first electrode of the sixth transistor T6 may be increased. The difference between the voltage of the control electrode of the sixth transistor T6 and the voltage of the first electrode of the sixth transistor T6 is greater than the threshold voltage of the sixth transistor T6. Accordingly, the sixth transistor T6 may be turned on and the first stage ST[1] may stably output the second power supply voltage VGL2 as the first gate signal SS[1]. Accordingly, the stability and the reliability of the gate driver 300 may be improved.

The seventh transistor T7 may be turned on in response to the voltage of the second control node Q and the eighth transistor T8 may be turned off in response to the voltage of the second control node Q. Accordingly, the seventh transistor T7 may transmit the third power supply voltage VGH to the second output node NO2 and the voltage of the second output node NO2 may maintain the level of the third power supply voltage VGH. Accordingly, the first stage ST[1] may output the first carry signal CR[1] having the level of the third power supply voltage VGH.

In an embodiment where the eighth transistor T8 is implemented as the N-type transistor, the eighth transistor T8 may be turned off and the leakage current of the eighth transistor T8 may be decreased. As the leakage current of the eighth transistor T8 is decreased, the first stage ST[1] may stably output the first carry signal CR[1] having the level of the third power supply voltage VGH. Accordingly, the stability and the reliability of the gate driver 300 may be improved. In addition, as the leakage current of the eighth transistor T8 is decreased, the power consumption of the display device 1 may be decreased.

Referring to FIGS. 4 and 8, the level of first clock signal CLK1 may be decreased from the level of the third power supply voltage VGH to the level of the first power supply voltage VGL1 in the fourth period TP4. The start signal FLM may maintain the level of the first power supply voltage VGL1.

The first transistor T1 may be turned on in response to the first clock signal CLK1 having the level of the first power supply voltage VGL1. The first transistor T1 may transmit the start signal FLM to the first control node QB. Accordingly, the level of the voltage of the first control node QB may be decreased from the level of the third power supply voltage VGH to the level of the first power supply voltage VGL1.

The third transistor T3 may be turned off in response to the start signal FLM.

The fourth transistor T4 may be turned on in response to the voltage of the first control node QB having the level of the first power supply voltage VGL1. The fourth transistor T4 may transmit the third power supply voltage VGH to the third control node A. Accordingly, the level of the voltage of the third control node A may be increased from the level of the first power supply voltage VGL1 to the level of the third power supply voltage VGH.

In an embodiment where the third transistor T3 is implemented as the N-type transistor, the third transistor T3 may be turned off. Accordingly, the leakage current of the third transistor T3 may be decreased and the voltage of the third control node A may stably maintain the level of the third power supply voltage VGH. Accordingly, the stability and the reliability of the gate driver 300 may be improved. In addition, as the leakage current of the third transistor is decreased, the power consumption of the display device 1 may be decreased.

The second transistor T2 may be turned on in response to the first power supply voltage VGL1. The second transistor T2 may transmit the voltage of the third control node A to the second control node Q. Accordingly, the level of the voltage of the second control node Q may be increased from the level of the boosting voltage VQ to the level of the third power supply voltage VGH.

The fifth transistor T5 may be turned on in response to the voltage of the first control node QB and the sixth transistor T6 may be turned off in response to the voltage of the second control node Q. The fifth transistor T5 may transmit the third power supply voltage VGH to the first output node NO1 and the level of the voltage of the first output node NO1 may be increased from the level of the second power supply voltage VGL2 to the level of the third power supply voltage VGH. Accordingly, the first stage ST[1] may output the first gate signal SS[1] having the level of the third power supply voltage VGH.

The seventh transistor T7 may be turned off in response to the voltage of the second control node Q and the eighth transistor T8 may be turned on in response to the voltage of the second control node Q. The eighth transistor T8 may transmit the first power supply voltage VGL1 to the second output node NO2 and the level of the voltage of the second output node NO2 may be decreased from the level of the third power supply voltage VGH to the level of the first power supply voltage VGL1. Accordingly, the first stage ST[1] may output the first carry signal CR[1] having the level of the first power supply voltage VGL1.

In an embodiment where the eighth transistor T8 is implemented as the N-type transistor, the difference between the voltage of the control electrode of the eighth transistor T8 and the voltage of the second electrode of the eighth transistor T8 may be increased. The difference between the voltage of the control electrode of the eighth transistor T8 and the voltage of the second electrode of the eighth transistor T8 may be greater than the threshold voltage of the eighth transistor T8. Accordingly, the eighth transistor T8 may be turned on and the first stage ST[1] may stably output the first power supply voltage VGL1 as the first carry signal CR[1]. Accordingly, the stability and the reliability of the gate driver 300 may be improved.

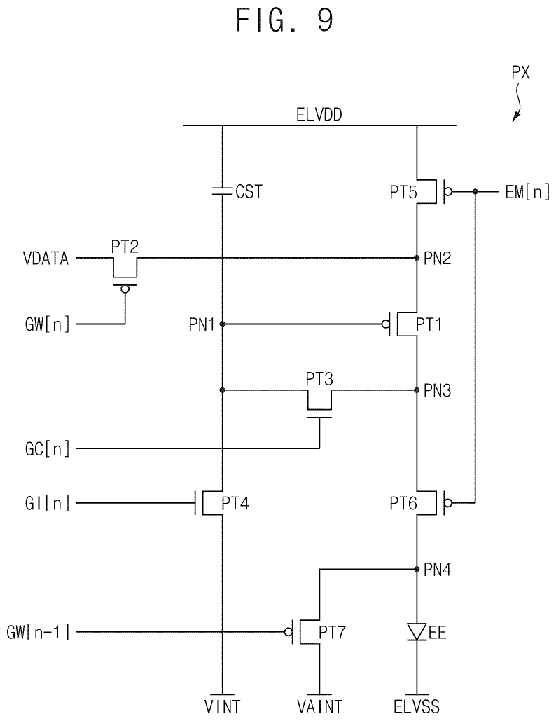

FIG. 9 is a circuit diagram illustrating an embodiment of the pixel PX included in the display panel 100 included in the display device 1 of FIG. 1.

Referring to FIG. 9, an embodiment of the pixel PX may include first to seventh pixel transistors PT1 to PT7, storage capacitor CST, and a light emitting element EE, but the pixel PX is not limited thereto.

In an embodiment, the gate signals SS output from the stages included in the gate driver 300 may be applied to the pixels PX. In an embodiment, for example, the n-th gate signal SS[n] may be the writing gate signal GW[n] applied to the second pixel transistor PT2. In an embodiment, for example, the n-th gate signal SS[n] may be the compensation gate signal GC[n] applied to the third pixel transistor PT3. In an embodiment, for example, the n-th gate signal SS[n] may be the initialization gate signal GI[n] applied to the fourth pixel transistor PT4.

The first pixel transistor PT1 may include a control electrode connected to a first pixel node PN1, a first electrode connected to a second pixel node PN2, and a second electrode connected to a third pixel node PN3. The first pixel transistor PT1 may generate a driving current based on a difference between a voltage of the first pixel node PN1 and a voltage of the second pixel node PN2.

The second pixel transistor PT2 may include a control electrode that receives the writing gate signal GW, a first electrode that receives the data voltage VDATA, and a second electrode connected to the second pixel node PN2. The second pixel transistor PT2 may transmit the data voltage VDATA to the second pixel node PN2 in response to the writing gate signal GW.

The third pixel transistor PT3 may include a control electrode that receives the compensation gate signal GC, a first electrode connected to the third pixel node PN3, and a second electrode connected to the first pixel node PN1. The third pixel transistor PT3 may diode connect the control electrode of the first pixel transistor PT1 and the second electrode of the first pixel transistor PT1 in response to the compensation gate signal GC.

The fourth pixel transistor PT4 may include a control electrode that receives the initialization gate signal, a first electrode that receives an initialization voltage VINT, a second electrode connected to the first pixel node PN1. The fourth pixel transistor PT4 may transmit the initialization voltage VINT to the first pixel node PN1 in response to the initialization gate signal GI.

The fifth pixel transistor PT5 may include a control electrode that receives the emission signal EM[n], a first electrode that receives a first pixel power supply voltage ELVDD, and a second electrode connected to the second pixel node PN2.

The sixth pixel transistor PT6 may include a control electrode that receives the emission signal EM[n], a first electrode connected to the third pixel node PN3, and a second electrode connected a fourth pixel node PN4.

The fifth pixel transistor PT5 and the sixth pixel transistor PT6 may control the emission of the light emitting element EE in response to the emission signal EM[n].

The seventh pixel transistor PT7 may include a control electrode that receives a previous writing gate signal GW[n−1], a first electrode that receives an anode initialization voltage VAINT, and a second electrode connected to the fourth pixel node PN4. The seventh pixel transistor PT7 may transmit the anode initialization voltage VAINT to the fourth pixel node PN4 in response to the previous writing gate signal GW[n−1].

The storage capacitor CST may include a first electrode that receives the first pixel power supply voltage ELVDD and a second electrode connected to the first pixel node PN1. The storage capacitor may store the data voltage VDATA.

The light emitting element EE may include an anode connected to the fourth pixel node PN4 and a cathode that receives a second pixel power supply voltage ELVSS. The light emitting element EE may emit a light based on the driving current. The magnitude of the driving current is determined based on a level of the data voltage VDATA, so that the magnitude of the light emission of (or intensity of light emitted by) the light emitting element EE may be determined based on the level of the data voltage VDATA.

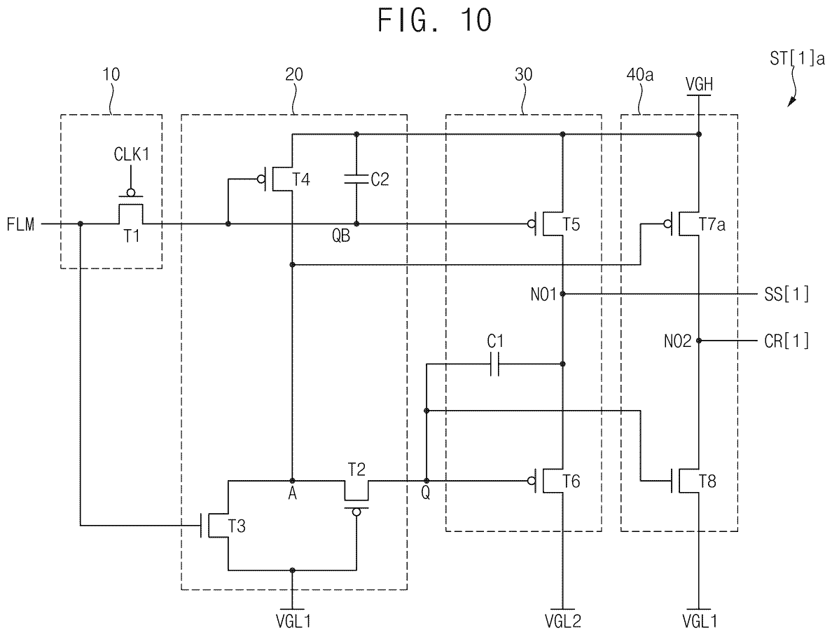

FIG. 10 is a circuit diagram illustrating another embodiment of a stage ST[1] a included in the gate driver 300 of FIG. 2.

Referring to FIG. 10, an embodiment of the stage ST[1] a may include the input circuit 10, the control circuit 20, the first output circuit 30, and a second output circuit 40a. The stage ST[1] a shown in FIG. 10 is substantially the same as the stage ST[1] of the FIG. 3 except for a structure of a seventh transistor T7a of the second output circuit 40a. Thus, the same reference numerals will be used to refer to the same or like parts as those described above with reference to FIG. 3 and any repetitive detailed description thereof will be omitted or simplified.

In an embodiment, as shown in FIG. 10, the seventh transistor T7a may include a control electrode connected to the third control node A, a first electrode that receives the third power supply voltage VGH, and a second electrode connected to the second output node NO2.

When the voltage of the third control node A has the level of the first power supply voltage VGL1, the seventh transistor T7a may be turned on. In addition, when the voltage of the third control node A has the third power supply voltage VGH, the seventh transistor T7a may be turned off.

The third transistor T3 and the eighth transistor T8 may be implemented as the N-type transistors and the first transistor T1, the second transistor T2, and the fourth to seventh transistors T4 to T7a may be implemented as the P-type transistors. In an embodiment, for example, the third transistor T3 and the eighth transistor T8 may be implemented as the N-type metal oxide transistors and the first transistor T1, the second transistor T2, and the fourth to seventh transistors T4 to T7a may be implemented as the LTPS transistors.

In an embodiment, the first power supply voltage VGL1 and the second power supply voltage VGL2 may be less than about zero (0) V and the third power supply voltage VGH may be greater than about zero (0) V. In addition, the level of the first power supply voltage VGL1 may be lower than the level of the second power supply voltage VGL2.

In addition, when the level of the first gate signal SS[1] is decreased from the level of the third power supply voltage VGH to the second power supply voltage VGL2, the second control node Q may have the boosting voltage VQ. The boosting voltage VQ may be calculated by the following equation: VQ=VGL1−|Vth_T2|−(VGH−VGL2), where VQ denotes the boosting voltage VQ, VGL1 denotes the first power supply voltage VGL1, Vth_T2 denotes the threshold voltage of the second transistor T2, VGH denotes the third power supply voltage VGH, and VGL2 is the second power supply voltage VGL2.

In an embodiment where the sixth transistor T6 is implemented as the P-type transistor and the voltage of the second control node Q has the level of the boosting voltage VQ, the difference between the voltage of the control electrode of the sixth transistor T6 and the voltage of the first electrode of the sixth transistor T6 may be increased. Accordingly, the threshold voltage of the sixth transistor T6 is varied, the difference between the voltage of the control electrode of the sixth transistor T6 and the voltage of the first electrode of the sixth transistor T6 may be greater than the threshold voltage of the sixth transistor T6. That is, the sixth transistor T6 may be turned on. Accordingly, the sixth transistor T6 may stably transmit the second power supply voltage VGL2 to the first output node NO1 and the first stage ST[1] a may stably output the first gate signal SS[1] having the level of the second power supply voltage VGL2. Accordingly, the stability and the reliability of the gate driver 300 may be improved.

In an embodiment, the first power supply voltage VGL1 and the second power supply voltage VGL2 may be less than about zero (0) V and the third power supply voltage VGH may be greater than about zero (0) V. In addition, the level of the first power supply voltage VGL1 may be higher than the level of the second power supply voltage VGL2.

In such an embodiment, the level of the first power supply voltage VGL1 is higher than the level of the second power supply voltage VGL2, such that the power consumption of the display device 1 may be decreased.

In an embodiment, where the eighth transistor T8 is implemented as the N-type transistor and the voltage of the second control node Q has the level of the third power supply voltage VGH, the difference between the voltage of the control electrode of the eighth transistor T8 and the voltage of the second electrode of the eighth transistor T8 may be increased. The difference between the voltage of the control electrode of the eighth transistor T8 and the voltage of the second electrode of the eighth transistor T8 may be greater than the threshold voltage of the eighth transistor T8. Accordingly, the eighth transistor T8 may be turned on and the eighth transistor T8 may transmit the first power supply voltage VGL1 to the first output node NO1. Accordingly, the first stage ST[1] a may stably output the first carry signal CR[1] having the level of the first power supply voltage VGL1 and the stability and the reliability of the gate driver 300 may be improved.

In an embodiment where the seventh transistor T7a is implemented as the P-type transistor and the voltage of the third control node A has the level of the first power supply voltage VGL1, the seventh transistor T7a may be turned on. In addition, when the eighth transistor T8 is implemented as the N-type transistor and the voltage of the second control node Q has the level of the boosting voltage VQ, the eighth transistor T8 may be turned off. Accordingly, the leakage current of the eighth transistor T8 may be decreased and the first stage ST[1] a may stably output the first gate signal SS[1] having the level of the third power supply voltage VGH. Accordingly, the stability and the reliability of the gate driver 300 may be improved. In addition, as the leakage current of the eighth transistor T8 is decreased, the power consumption of the display device 1 may be decreased.

In an embodiment, where the third transistor T3 is implemented as the N-type transistor and the level of the start signal FLM is increased form the level of the first power supply voltage VGL1 to the level of the third power supply voltage VGH, the difference between the voltage of the control electrode of the third transistor T3 and the voltage of the second electrode of the third transistor T3 may be increased. The difference between the voltage of the control electrode of the third transistor T3 and the voltage of the second electrode of the third transistor T3 may be greater than the threshold voltage of the third transistor T3. Accordingly, the third transistor T3 may be turned on and the third transistor T3 may transmit the first power supply voltage VGL1 to the third control node A. The voltage of the third control node A may stably maintain the level of the first power supply voltage VGL1 and the stability and the reliability of the gate driver 300 may be improved.

In an embodiment, where the third transistor T3 is implemented as the N-type transistor and the start signal FLM has the level of the first power supply voltage VGL1, the third transistor T3 may be turned off. Accordingly, the leakage current of the third transistor T3 may be decreased and the voltage of the third control node A may stably maintain the level of the first power supply voltage VGL1 or the level of the third power supply voltage VGH. Accordingly, the stability and the reliability of the gate driver 300 may be increased. In addition, as the leakage current of the third transistor T3 is decreased, the power consumption of the display device 1 may be decreased.

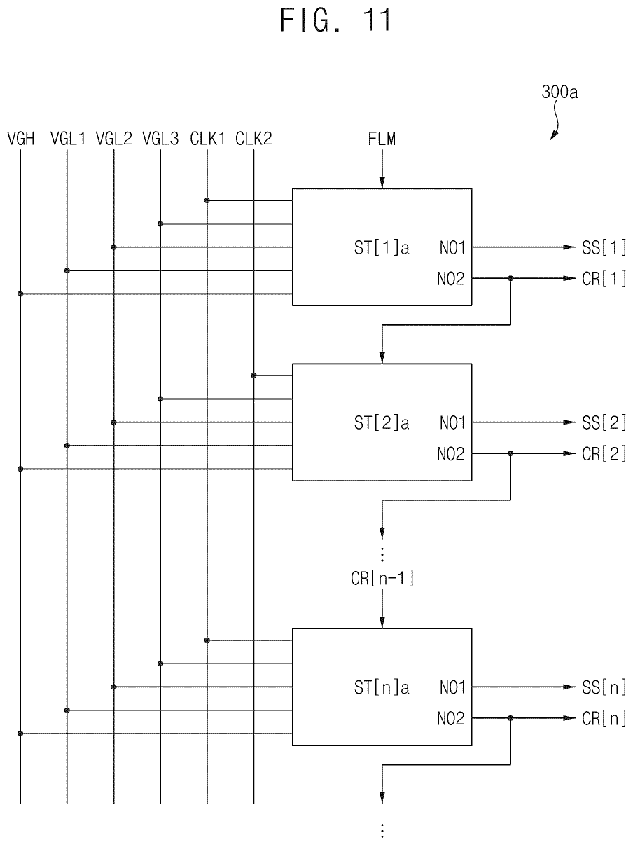

FIG. 11 is a block diagram illustrating another embodiment of a gate driver 300a included in the display device 1 of FIG. 1.

Referring to FIG. 11, the gate driver 300a may include stages. In an embodiment, for example, the gate driver 300a may include a first stage ST[1] a and a second stage ST[2] a. In addition, the gate driver 300a may include n-th stage ST[n] a. The gate driver 300a shown in FIG. 11 is substantially the same as the gate driver 300 of the FIG. 2 except that a fourth power supply voltage VGL3 is applied to the stages. Thus, the same reference numerals will be used to refer to the same or like parts as those described in the previous embodiment of FIG. 2 and any repetitive detailed description thereof will be omitted or simplified.

In an embodiment, each of the stages may receive the first power supply voltage VGL1, the second power supply voltage VGL2, the third power supply voltage VGH, and the fourth power supply voltage VGL3. In an embodiment, for example, the first power supply voltage VGL1, the second power supply voltage VGL2, and the fourth power supply voltage VGL3 may be less than about zero (0) V and the third power supply voltage VGH may be greater than about zero (0) V. In an embodiment, for example, the level of the first power supply voltage VGL1 may be lower than the level of the second power supply voltage VGL2 and a level of the fourth power supply voltage VGL3 may be lower than the level of the first power supply voltage VGL1. In an embodiment, for example, the level of the first power supply voltage VGL1 may be higher than the level of the second power supply voltage VGL2 and the level of the fourth power supply voltage VGL3 may be lower than the level of the first power supply voltage VGL1.

Each of the stages may receive the first clock signal CLK1 or the second clock signal CLK2. In addition, each of the stages may receive the input signal.

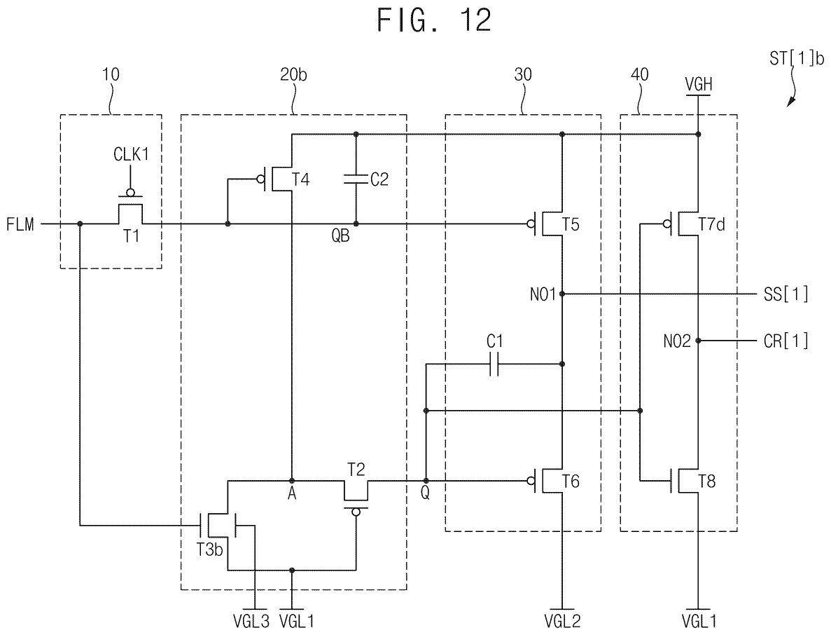

FIG. 12 is a circuit diagram illustrating an embodiment of a stage ST[1] b included in the gate driver 300a of FIG. 11.

Referring to FIG. 12, an embodiment of the stage ST[1] b may include the input circuit 10, a control circuit 20b, the first output circuit 30, and the second output circuit 40. The stage ST[1] b shown in FIG. 12 is substantially the same as the stage ST[1] of the FIG. 3 except that the fourth power supply voltage VGL3 is applied to a third transistor T3b included in the control circuit 20b. Thus, the same reference numerals will be used to refer to the same or like parts as those described in the previous embodiment of FIG. 3 and any repetitive detailed description thereof will be omitted or simplified.

In an embodiment, as shown in FIG. 12, the third transistor T3b may include a control electrode that receives the start signal FLM, the first electrode connected to the third control node A, and the second electrode that receives the first power supply voltage VGL1. In addition, the third transistor T3b may further include a second control electrode that receives the fourth power supply voltage VGL3.

In an embodiment, the third transistor T3b may be implemented as the N-type transistor and the level of the fourth power supply voltage VGL3 may be lower than the level of the first power supply voltage VGL1. As the fourth power supply voltage VGL3 is applied to the second control electrode of the third transistor T3b, the threshold voltage of the third transistor T3b may be shifted. Accordingly, the third transistor T3b may maintain an initialization threshold voltage and a stability and a reliability of the gate driver 300a may be improved.

In an embodiment, the third transistor T3b and the eighth transistor T8 may be implemented as the N-type transistors, and the first transistor T1, the second transistor T2, and the fourth to seventh transistors T4 to T7 may be implemented as the P-type transistors. In an embodiment, for example, the third transistor T3b and the eighth transistor T8 may be implemented as the N-type metal oxide transistors and the first transistor T1, the second transistor T2, and the fourth to seventh transistors T4 to T7 may be implemented as the LTPS transistors.

In an embodiment where the third transistor T3b and the eighth transistor T8 are implemented as the N-type transistors, the leakage current of the third transistor T3b and the eighth transistor T8 may be decreased. Accordingly, the stability and the reliability of the gate driver 300a may be improved. In addition, the power consumption of the display device 1 may be decreased.

In an embodiment where the first transistor T1, the second transistor T2, and the fourth to seventh transistors T4 to T7 are implemented as the P-type transistors, the driving current of the first transistor T1, the second transistor T2, and the fourth to seventh transistors T4 to T7 may be increased. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be lower than the level of the second power supply voltage VGL2 and the level of the fourth power supply voltage VGL3 may be lower than the level of the first power supply voltage VGL1.

In addition, when the level of the first gate signal SS[1] is decreased from the level of the third power supply voltage VGH to the level of the second power supply voltage VGL2, the second control node Q may have the boosting voltage VQ. The boosting voltage VQ may be calculated by the following equation: VQ=VGL1−|Vth_T2|−(VGH−VGL2), where VQ denotes the boosting voltage VQ, VGL1 denotes the first power supply voltage VGL1, Vth_T2 denotes the threshold voltage of the second transistor T2, VGH denotes the third power supply voltage VGH, and VGL2 denotes the second power supply voltage VGL2.

In an embodiment where the sixth transistor T6 is implemented as the P-type transistor and the voltage of the second control node Q has the level of the boosting voltage VQ, the difference between the voltage of the control electrode of the sixth transistor T6 and the voltage of the first electrode of the sixth transistor T6 may be increased. Accordingly, even when the threshold voltage of the sixth transistor T6 is varied, the difference between the voltage of the control electrode of the sixth transistor T6 and the voltage of the first electrode of the sixth transistor T6 may be greater than the threshold voltage of the sixth transistor T6. That is, the sixth transistor T6 may be turned on. Accordingly, the sixth transistor T6 may stably transmit the second power supply voltage VGL2 to the first output node NO1 and the first stage ST[1] b may stably output the first gate signal SS[1] having the level of the second power supply voltage VGL2. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be higher than the level of the second power supply voltage VGL2 and the level of the fourth power supply voltage VGL3 may be lower than the level of the first power supply voltage VGL1.

In such an embodiment, the level of the first power supply voltage VGL1 is higher than the level of the second power supply voltage VGL2, such that the power supply voltage of the display device 1 may be decreased.

In an embodiment, where the eighth transistor T8 is implemented as the N-type transistor and the voltage of the second control node Q has the level of the third power supply voltage VGH, the difference between the voltage of the control electrode of the eighth transistor T8 and the voltage of the second electrode of the eighth transistor T8 may be increased. The difference between the voltage of the control electrode of the eighth transistor T8 and the voltage of the second electrode of the eighth transistor T8 may be greater than the threshold voltage of the eighth transistor T8. Accordingly, the eighth transistor T8 may be turned on and the eighth transistor T8 may transmit the first power supply voltage VGL1 to the first output node NO1. Accordingly, the first stage ST[1] b may stably output the carry signal CR[1] having the level of the first power supply voltage VGL1 and the stability and the reliability of the gate driver 300a may be improved.

In an embodiment, where the seventh transistor T7 is implemented as the P-type transistor, the eighth transistor T8 is implemented as the N-type transistor, the seventh transistor T7 is turned on, and the voltage of the second control node Q has the level of the boosting voltage VQ, the eighth transistor T8 may be turned off. Accordingly, the leakage current of the eighth transistor T8 may be decreased and the first stage ST[1] b may stably output the first gate signal SS[1] having the level of the third power supply voltage VGH. Accordingly, the stability and the reliability of the gate driver 300a may be increased. In addition, as the leakage current of the eighth transistor T8 is decreased, the power consumption of the display device 1 may be decreased.

In an embodiment, where the third transistor T3b is implemented as the N-type transistor and the level of the start signal FLM is increased form the level of the first power supply voltage VGL1 to the level of the third power supply voltage VGH, the difference between the voltage of the control electrode of the third transistor T3b and the voltage of the second electrode of the third transistor T3b may be increased. The difference between the voltage of the control electrode of the third transistor T3b and the voltage of the second electrode of the third transistor T3b may be greater than the threshold voltage of the third transistor T3b. Accordingly, the third transistor T3b may be turned on and the third transistor T3b may transmit the first power supply voltage VGL1 to the third control node A. The voltage of the third control node A may stably maintain the level of the first power supply voltage VGL1 and the stability and the reliability of the gate driver 300a may be improved.

In an embodiment, where the third transistor T3b is implemented as the N-type transistor and the start signal FLM has the level of the first power supply voltage VGL1, the third transistor T3b may be turned off. Accordingly, the leakage current of the third transistor T3b may be decreased and the voltage of the third control node A may stably maintain the level of the first power supply voltage VGL1 or the level of the third power supply voltage VGH. Accordingly, the stability and the reliability of the gate driver 300a may be increased. In addition, as the leakage current of the third transistor T3b is decreased, the power consumption of the display device 1 may be decreased.

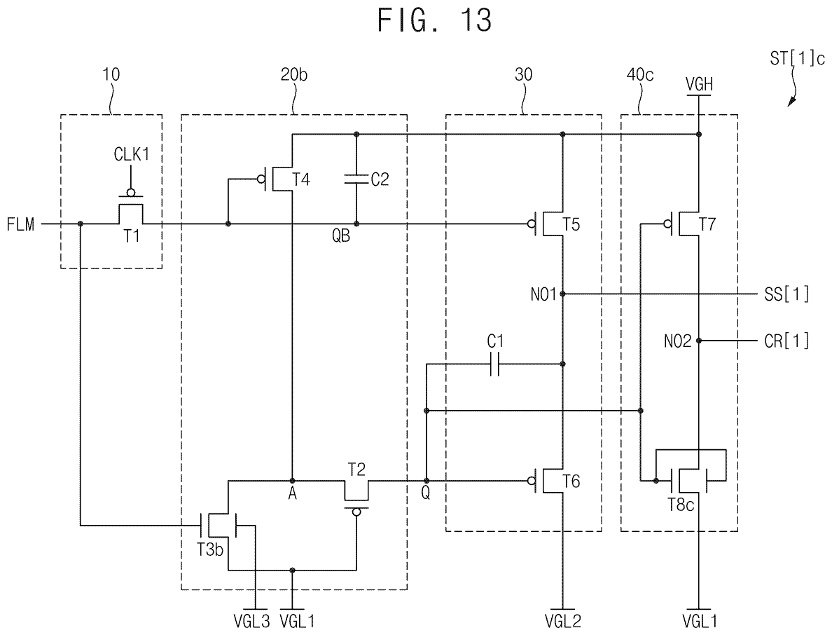

FIG. 13 is a circuit diagram illustrating another embodiment of a stage ST[1] c included in the gate driver 300a of FIG. 11.

Referring to FIG. 13, an embodiment of the stage ST[1] c may include the input circuit 10, the control circuit 20b, the first output circuit 30, and a second output circuit 40c. The stage ST[1] c shown in FIG. 13 is substantially the same as the stage ST[1] b of the FIG. 12 except that an eighth transistor T8c further includes a second control electrode. Thus, the same reference numerals will be used to refer to the same or like parts as those described in the previous embodiment of FIG. 12 and any repetitive detailed description thereof will be omitted or simplified.

The eighth transistor T8c may include the control electrode connected to the second control node Q, the first electrode connected to the second output node NO2, and the second electrode that receives the first power supply voltage VGL1. In addition, the eighth transistor T8c may further include the second control electrode connected to the control electrode of the eighth transistor T8c.

As the control electrode of the eighth transistor T8c is connected to the second control electrode of the eighth transistor T8c, a voltage of the second control electrode of the eighth transistor T8c may be the same as the voltage of the second control node Q.

In an embodiment, where the voltage of the second control node Q has the level of the boosting voltage VQ, as the voltage of the second control node Q having the level of the boosting voltage VQ is applied to the second control electrode of the eighth transistor T8c, a threshold voltage of the eighth transistor T8c may be shifted. The eighth transistor T8c may maintain the initialization threshold voltage. The eighth transistor T8c may be turned off and the leakage current of the eighth transistor T8c may be decreased. The first stage ST[1] c may stably output the first gate signal SS[1] having the level of the third power supply voltage VGH. Accordingly, the stability and the reliability of the gate driver 300a may be improved. In addition, as the leakage current of the eighth transistor T8c is decreased, the power consumption of the display device 1 may be decreased.

In an embodiment, the third transistor T3b and the eighth transistor T8c may be implemented as the N-type transistors and the first transistor T1, the second transistor T2, and the fourth to seventh transistors T4 to T7 may be implemented as the P-type transistors. In an embodiment, for example, the third transistor T3b and the eighth transistor T8c may be implemented as the N-type metal oxide transistors and the first transistor T1, the second transistor T2, and the fourth to seventh transistors T4 to T7 may be implemented as the LTPS transistors.

In an embodiment, where the third transistor T3b and the eighth transistor T8c are implemented as the N-type transistors, the leakage current of the third transistor T3b and the eighth transistor T8c may be decreased. Accordingly, the stability and the reliability of the gate driver 300a may be improved. In addition, the power consumption of the display device 1 may be decreased.

In an embodiment, where the third transistor T3b may be implemented as the N-type transistor and the level of the fourth power supply voltage VGL3 may be lower than the level of the first power supply voltage VGL1. As the fourth power supply voltage VGL3 is applied to the second control electrode of the third transistor T3b, the threshold voltage of the third transistor T3b may be shifted. Accordingly, the third transistor T3b may maintain the initialization threshold voltage and the stability and the reliability of the gate driver 300a may be improved.

In an embodiment, where the first transistor T1, the second transistor T2, and the fourth to seventh transistors T4 to T7 are implemented as the P-type transistors, the driving current of the first transistor T1, the second transistor T2, and the fourth to seventh transistors T4 to T7 may be increased. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be lower than the level of the second power supply voltage VGL2 and the level of the fourth power supply voltage VGL3 may be lower than the level of the first power supply voltage VGL1.

In addition, when the level of the first gate signal SS[1] is decreased from the level of the third power supply voltage VGH to the level of the second power supply voltage VGL2, the second control node Q may have the boosting voltage VQ. The boosting voltage VQ may be calculated by the following equation: VQ=VGL1−|Vth_T2|−(VGH−VGL2), where VQ denotes the boosting voltage VQ, VGL1 denotes the first power supply voltage VGL1, Vth_T2 denotes the threshold voltage of the second transistor T2, VGH denotes the third power supply voltage VGH, and VGL2 denotes the second power supply voltage VGL2.

In an embodiment, where the sixth transistor T6 is implemented as the P-type transistor and the voltage of the second control node Q has the level of the boosting voltage VQ, the difference between the voltage of the control electrode of the sixth transistor T6 and the voltage of the first electrode of the sixth transistor T6 may be increased. Accordingly, when the threshold voltage of the sixth transistor T6 is varied, the difference between the voltage of the control electrode of the sixth transistor T6 and the voltage of the first electrode of the sixth transistor T6 may be greater than the threshold voltage of the sixth transistor T6. That is, the sixth transistor T6 may be turned on. Accordingly, the sixth transistor T6 may stably transmit the second power supply voltage VGL2 to the first output node NO1 and the first stage ST[1] c may stably output the first gate signal SS[1] having the level of the second power supply voltage VGL2. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be higher than the level of the second power supply voltage VGL2 and the level of the fourth power supply voltage VGL3 may be lower than the level of the first power supply voltage VGL1.

In such an embodiment, the level of the first power supply voltage VGL1 is higher than the level of the second power supply voltage VGL2, such that the power supply voltage of the display device 1 may be decreased.

In an embodiment, where the eighth transistor T8c is implemented as the N-type transistor and the voltage of the second control node Q has the level of the third power supply voltage VGH, the difference between the voltage of the control electrode of the eighth transistor T8c and the voltage of the second electrode of the eighth transistor T8c may be increased. The difference between the voltage of the control electrode of the eighth transistor T8c and the voltage of the second electrode of the eighth transistor T8c may be greater than the threshold voltage of the eighth transistor T8c. Accordingly, the eighth transistor T8c may be turned on and the eighth transistor T8c may transmit the first power supply voltage VGL1 to the first output node NO1. Accordingly, the first stage ST[1] c may stably output the carry signal CR[1] having the level of the first power supply voltage VGL1 and the stability and the reliability of the gate driver 300a may be improved.

In an embodiment, where the seventh transistor T7 is implemented as the P-type transistor, the eighth transistor T8c is implemented as the N-type transistor, the seventh transistor T7 is turned on, and the voltage of the second control node Q has the level of the boosting voltage VQ, the eighth transistor T8c may be turned off. Accordingly, the leakage current of the eighth transistor T8c may be decreased and the first stage ST[1] c may stably output the first gate signal SS[1] having the level of the third power supply voltage VGH. Accordingly, the stability and the reliability of the gate driver 300a may be increased. In addition, as the leakage current of the eighth transistor T8c is decreased, the power consumption of the display device 1 may be decreased.

In an embodiment, where the third transistor T3b is implemented as the N-type transistor and the level of the start signal FLM is increased form the level of the first power supply voltage VGL1 to the level of the third power supply voltage VGH, the difference between the voltage of the control electrode of the third transistor T3b and the voltage of the second electrode of the third transistor T3b may be increased. The difference between the voltage of the control electrode of the third transistor T3b and the voltage of the second electrode of the third transistor T3b may be greater than the threshold voltage of the third transistor T3b. Accordingly, the third transistor T3b may be turned on and the third transistor T3b may transmit the first power supply voltage VGL1 to the third control node A. The voltage of the third control node A may stably maintain the level of the first power supply voltage VGL1 and the stability and the reliability of the gate driver 300a may be improved.

In an embodiment, where the third transistor T3b is implemented as the N-type transistor and the start signal FLM has the level of the first power supply voltage VGL1, the third transistor T3b may be turned off. Accordingly, the leakage current of the third transistor T3b may be decreased and the voltage of the third control node A may stably maintain the level of the first power supply voltage VGL1 or the level of the third power supply voltage VGH. Accordingly, the stability and the reliability of the gate driver 300a may be increased. In addition, as the leakage current of the third transistor T3b is decreased, the power consumption of the display device 1 may be decreased.

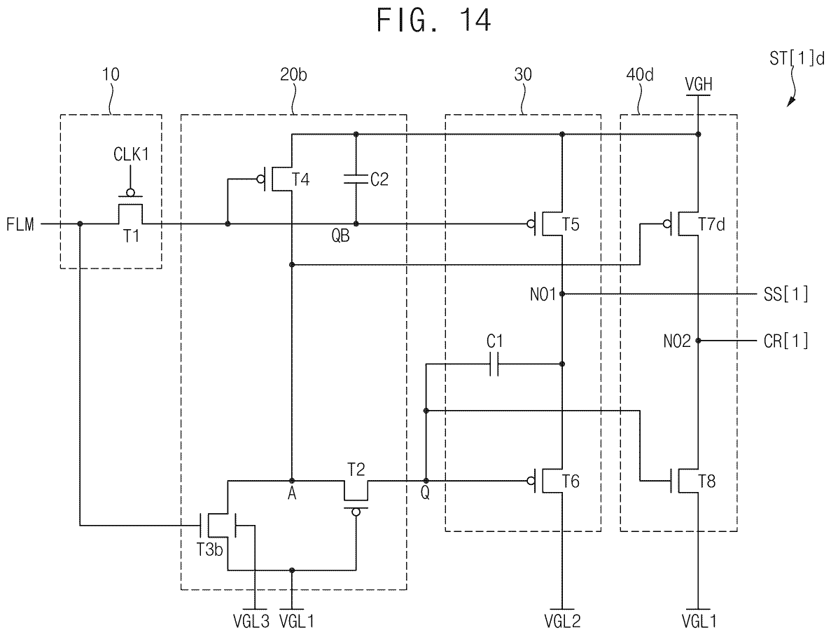

FIG. 14 is a circuit diagram illustrating another embodiment of a stage ST[1] d included in the gate driver 300a of FIG. 11.

Referring to FIG. 14, an embodiment of the stage ST[1] d may include the input circuit 10, the control circuit 20b, the first output circuit 30, and a second output circuit 40d. The stage ST[1] d shown in FIG. 14 is substantially the same as the stage ST[1] b of the FIG. 12 except for a structure of a seventh transistor T7d of the second output circuit 40d. Thus, the same reference numerals will be used to refer to the same or like parts as those described in the previous embodiment of FIG. 12 and any repetitive detailed description thereof will be omitted or simplified.

In an embodiment, as shown in FIG. 14, the seventh transistor T7d may include a control electrode connected to the third control node A, the first electrode that receives the third power supply voltage VGH, and the second electrode connected to the second output node NO2.

When the voltage of the third control node A has the level of the first power supply voltage VGL1, the seventh transistor T7d may be turned on. In addition, when the voltage of the third control node A has the level of the third power supply voltage VGH, the seventh transistor T7d may be turned off.

In an embodiment, the third transistor T3b may be implemented as the N-type transistor and the level of the fourth power supply voltage VGL3 may be lower than the level of the first power supply voltage VGL1. As the fourth power supply voltage VGL3 is applied to the second control electrode of the third transistor T3b, the threshold voltage of the third transistor T3b may be shifted. Accordingly, the third transistor T3b may maintain an initialization threshold voltage and a stability and a reliability of the gate driver 300a may be improved.

In an embodiment, the third transistor T3b and the eighth transistor T8 may be implemented as the N-type transistors and the first transistor T1, the second transistor T2, and the fourth to seventh transistors T4 to T7 may be implemented as the P-type transistors. In an embodiment, for example, the third transistor T3b and the eighth transistor T8 may be implemented as the N-type metal oxide transistors and the first transistor T1, the second transistor T2, and the fourth to seventh transistors T4 to T7 may be implemented as the LTPS transistors.

In an embodiment, where the third transistor T3b and the eighth transistor T8 are implemented as the N-type transistors, the leakage current of the third transistor T3b and the eighth transistor T8 may be decreased. Accordingly, the stability and the reliability of the gate driver 300a may be improved. In addition, the power consumption of the display device 1 may be decreased.

In an embodiment, where the first transistor T1, the second transistor T2, and the fourth to seventh transistors T4 to T7 are implemented as the P-type transistors, the driving current of the first transistor T1, the second transistor T2, and the fourth to seventh transistors T4 to T7 may be increased. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be lower than the level of the second power supply voltage VGL2 and the level of the fourth power supply voltage VGL3 may be lower than the level of the first power supply voltage VGL1.

In addition, when the level of the first gate signal SS[1] is decreased from the level of the third power supply voltage VGH to the level of the second power supply voltage VGL2, the second control node Q may have the boosting voltage VQ. The boosting voltage VQ may be calculated by the following equation: VQ=VGL1−|Vth_T2|−(VGH−VGL2), where VQ denotes the boosting voltage VQ, VGL1 denotes the first power supply voltage VGL1, Vth_T2 denotes the threshold voltage of the second transistor T2, VGH denotes the third power supply voltage VGH, and VGL2 denotes the second power supply voltage VGL2.

In an embodiment, where the sixth transistor T6 is implemented as the P-type transistor and the voltage of the second control node Q has the level of the boosting voltage VQ, the difference between the voltage of the control electrode of the sixth transistor T6 and the voltage of the first electrode of the sixth transistor T6 may be increased. Accordingly, when the threshold voltage of the sixth transistor T6 is varied, the difference between the voltage of the control electrode of the sixth transistor T6 and the voltage of the first electrode of the sixth transistor T6 may be greater than the threshold voltage of the sixth transistor T6. That is, the sixth transistor T6 may be turned on. Accordingly, the sixth transistor T6 may stably transmit the second power supply voltage VGL2 to the first output node NO1 and the first stage ST[1] b may stably output the first gate signal SS[1] having the level of the second power supply voltage VGL2. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be higher than the level of the second power supply voltage VGL2 and the level of the fourth power supply voltage VGL3 may be lower than the level of the first power supply voltage VGL1.

In such an embodiment, the level of the first power supply voltage VGL1 is higher than the level of the second power supply voltage VGL2, such that the power supply voltage of the display device 1 may be decreased.

In an embodiment, where the eighth transistor T8 is implemented as the N-type transistor and the voltage of the second control node Q has the level of the third power supply voltage VGH, the difference between the voltage of the control electrode of the eighth transistor T8 and the voltage of the second electrode of the eighth transistor T8 may be increased. The difference between the voltage of the control electrode of the eighth transistor T8 and the voltage of the second electrode of the eighth transistor T8 may be greater than the threshold voltage of the eighth transistor T8. Accordingly, the eighth transistor T8 may be turned on and the eighth transistor T8 may transmit the first power supply voltage VGL1 to the first output node NO1. Accordingly, the first stage ST[1] d may stably output the carry signal CR[1] having the level of the first power supply voltage VGL1 and the stability and the reliability of the gate driver 300a may be improved.

In an embodiment, where the seventh transistor T7d is implemented as the P-type transistor, the eighth transistor T8 is implemented as the N-type transistor, the seventh transistor T7d is turned on, and the voltage of the second control node Q has the level of the boosting voltage VQ, the eighth transistor T8 may be turned off. Accordingly, the leakage current of the eighth transistor T8 may be decreased and the first stage ST[1] b may stably output the first gate signal SS[1] having the level of the third power supply voltage VGH. Accordingly, the stability and the reliability of the gate driver 300a may be increased. In addition, as the leakage current of the eighth transistor T8 is decreased, the power consumption of the display device 1 may be decreased.

In an embodiment, where the third transistor T3b is implemented as the N-type transistor and the level of the start signal FLM is increased form the level of the first power supply voltage VGL1 to the level of the third power supply voltage VGH, the difference between the voltage of the control electrode of the third transistor T3b and the voltage of the second electrode of the third transistor T3b may be increased. The difference between the voltage of the control electrode of the third transistor T3b and the voltage of the second electrode of the third transistor T3b may be greater than the threshold voltage of the third transistor T3b. Accordingly, the third transistor T3b may be turned on and the third transistor T3b may transmit the first power supply voltage VGL1 to the third control node A. The voltage of the third control node A may stably maintain the level of the first power supply voltage VGL1 and the stability and the reliability of the gate driver 300a may be improved.

In an embodiment, where the third transistor T3b is implemented as the N-type transistor and the start signal FLM has the level of the first power supply voltage VGL1, the third transistor T3b may be turned off. Accordingly, the leakage current of the third transistor T3b may be decreased and the voltage of the third control node A may stably maintain the level of the first power supply voltage VGL1 or the level of the third power supply voltage VGH. Accordingly, the stability and the reliability of the gate driver 300a may be increased. In addition, as the leakage current of the third transistor T3b is decreased, the power consumption of the display device 1 may be decreased.

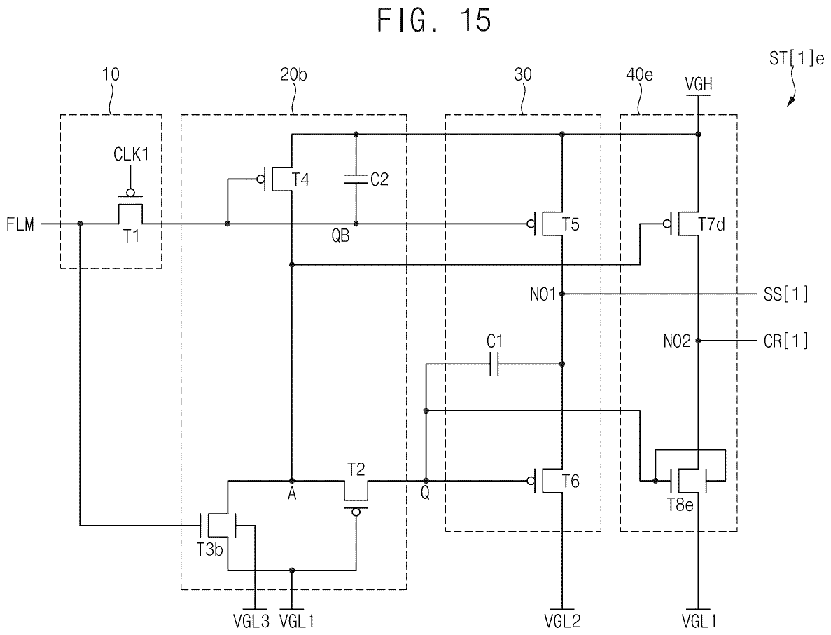

FIG. 15 is a circuit diagram illustrating another embodiment of a stage ST[1] e included in the gate driver 300a of FIG. 11.

Referring to FIG. 15, an embodiment of the stage ST[1] e may include the input circuit 10, the control circuit 20b, the first output circuit 30, and a second output circuit 40e. The stage ST[1] e shown in FIG. 15 is substantially the same as the stage ST[1] d of the FIG. 14 except that an eighth transistor T8e further includes a second control electrode. Thus, the same reference numerals will be used to refer to the same or like parts as those described in the previous embodiment of FIG. 14 and any repetitive detailed description thereof will be omitted or simplified.

In an embodiment, as shown in FIG. 15, the eighth transistor T8e include the control electrode connected to the second control node Q, the first electrode connected to the second output node NO2, and the second electrode that receives the first power supply voltage VGL1. In addition, the eighth transistor T8e may further include the second control electrode connected to the control electrode of the eighth transistor T8e.

As the control electrode of the eighth transistor T8e is connected to the second control electrode of the eighth transistor T8e, a voltage of the second control electrode of the eighth transistor T8e may be the same as the voltage of the second control node Q.

In an embodiment, when the voltage of the second control node Q has the level of the boosting voltage VQ, as the voltage of the second control node Q having the level of the boosting voltage VQ is applied to the second control electrode of the eighth transistor T8e, a threshold voltage of the eighth transistor T8e may be shifted. The eighth transistor T8e may maintain an initialization threshold voltage. The eighth transistor T8e may be turned off and the leakage current of the eighth transistor T8e may be decreased. The first stage ST[1] e may stably output the first gate signal SS[1] having the level of the third power supply voltage VGH. Accordingly, the stability and the reliability of the gate driver 300a may be improved. In addition, as the leakage current of the eighth transistor T8e is decreased, the power consumption of the display device 1 may be decreased.

In an embodiment, the third transistor T3b may be implemented as the N-type transistor and the level of the fourth power supply voltage VGL3 may be lower than the level of the first power supply voltage VGL1. As the fourth power supply voltage VGL3 is applied to the second control electrode of the third transistor T3b, the threshold voltage of the third transistor T3b may be shifted. Accordingly, the third transistor T3b may maintain an initialization threshold voltage and a stability and a reliability of the gate driver 300a may be improved.

In an embodiment, the third transistor T3b and the eighth transistor T8e may be implemented as the N-type transistors and the first transistor T1, the second transistor T2, and the fourth to seventh transistors T4 to T7d may be implemented as the P-type transistors. In an embodiment, for example, the third transistor T3b and the eighth transistor T8e may be implemented as the N-type metal oxide transistors and the first transistor T1, the second transistor T2, and the fourth to seventh transistors T4 to T7d may be implemented as the LTPS transistors.

In an embodiment where the third transistor T3b and the eighth transistor T8e are implemented as the N-type transistors, the leakage current of the third transistor T3b and the eighth transistor T8e may be decreased. Accordingly, the stability and the reliability of the gate driver 300a may be improved. In addition, the power consumption of the display device 1 may be decreased.

In an embodiment where the first transistor T1, the second transistor T2, and the fourth to seventh transistors T4 to T7 are implemented as the P-type transistors, the driving current of the first transistor T1, the second transistor T2, and the fourth to seventh transistors T4 to T7 may be increased. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be lower than the level of the second power supply voltage VGL2 and the level of the fourth power supply voltage VGL3 may be lower than the level of the first power supply voltage VGL1.

In addition, when the level of the first gate signal SS[1] is decreased from the level of the third power supply voltage VGH to the level of the second power supply voltage VGL2, the second control node Q may have the boosting voltage VQ. The boosting voltage VQ may be calculated by the following equation: VQ=VGL1−|Vth_T2|−(VGH−VGL2), where VQ denotes the boosting voltage VQ, VGL1 denotes the first power supply voltage VGL1, Vth_T2 denotes the threshold voltage of the second transistor T2, VGH denotes the third power supply voltage VGH, and VGL2 denotes the second power supply voltage VGL2.

In an embodiment where the sixth transistor T6 is implemented as the P-type transistor and the voltage of the second control node Q has the level of the boosting voltage VQ, the difference between the voltage of the control electrode of the sixth transistor T6 and the voltage of the first electrode of the sixth transistor T6 may be increased. Accordingly, when the threshold voltage of the sixth transistor T6 is varied, the difference between the voltage of the control electrode of the sixth transistor T6 and the voltage of the first electrode of the sixth transistor T6 may be greater than the threshold voltage of the sixth transistor T6. That is, the sixth transistor T6 may be turned on. Accordingly, the sixth transistor T6 may stably transmit the second power supply voltage VGL2 to the first output node NO1 and the first stage ST[1] b may stably output the first gate signal SS[1] having the level of the second power supply voltage VGL2. Accordingly, the stability and the reliability of the gate driver 300a may be improved.

In an embodiment, the first power supply voltage VGL1, the second power supply voltage VGL2, and the fourth power supply voltage VGL3 may be less than about zero (0) V and the third power supply voltage VGH may be greater than about zero (0) V. In addition, the level of the first power supply voltage VGL1 may be higher than the level of the second power supply voltage VGL2 and the level of the fourth power supply voltage VGL3 may be lower than the level of the first power supply voltage VGL1.

In such an embodiment, the level of the first power supply voltage VGL1 is higher than the level of the second power supply voltage VGL2, such that the power supply voltage of the display device 1 may be decreased.

In an embodiment, where the eighth transistor T8e is implemented as the N-type transistor and the voltage of the second control node Q has the level of the third power supply voltage VGH, the difference between the voltage of the control electrode of the eighth transistor T8e and the voltage of the second electrode of the eighth transistor T8e may be increased. The difference between the voltage of the control electrode of the eighth transistor T8e and the voltage of the second electrode of the eighth transistor T8e may be greater than the threshold voltage of the eighth transistor T8. Accordingly, the eighth transistor T8 may be turned on and the eighth transistor T8 may transmit the first power supply voltage VGL1 to the first output node NO1. Accordingly, the first stage ST[1] e may stably output the carry signal CR[1] having the level of the first power supply voltage VGL1 and the stability and the reliability of the gate driver 300a may be improved.

In an embodiment, where the seventh transistor T7d is implemented as the P-type transistor and the voltage of the third control node A has the level of the first power supply voltage VGL1, the seventh transistor T7d may be turned on. In addition, when the eighth transistor T8e is implemented as the N-type transistor and the voltage of the second control node Q has the level of the boosting voltage VQ, the eighth transistor T8e may be turned off. Accordingly, the leakage current of the eighth transistor T8e may be decreased and the first stage ST[1] e may stably output the first gate signal SS[1] having the level of the third power supply voltage VGH. Accordingly, the stability and the reliability of the gate driver 300a may be improved. In addition, as the leakage current of the eighth transistor T8e is decreased, the power consumption of the display device 1 may be decreased.

In an embodiment, where the third transistor T3b is implemented as the N-type transistor and the level of the start signal FLM is increased form the level of the first power supply voltage VGL1 to the level of the third power supply voltage VGH, the difference between the voltage of the control electrode of the third transistor T3b and the voltage of the second electrode of the third transistor T3b may be increased. The difference between the voltage of the control electrode of the third transistor T3b and the voltage of the second electrode of the third transistor T3b may be greater than the threshold voltage of the third transistor T3b. Accordingly, the third transistor T3b may be turned on and the third transistor T3b may transmit the first power supply voltage VGL1 to the third control node A. The voltage of the third control node A may stably maintain the level of the first power supply voltage VGL1 and the stability and the reliability of the gate driver 300a may be improved.

In an embodiment, where the third transistor T3b is implemented as the N-type transistor and the start signal FLM has the level of the first power supply voltage VGL1, the third transistor T3b may be turned off. Accordingly, the leakage current of the third transistor T3b may be decreased and the voltage of the third control node A may stably maintain the level of the first power supply voltage VGL1 or the level of the third power supply voltage VGH. Accordingly, the stability and the reliability of the gate driver 300a may be increased. In addition, as the leakage current of the third transistor T3b is decreased, the power consumption of the display device 1 may be decreased.

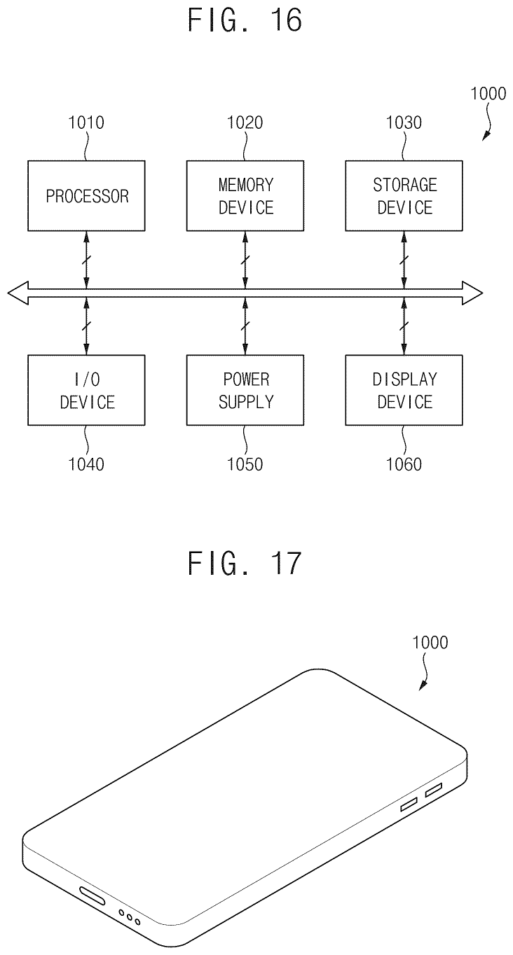

FIG. 16 is a block diagram illustrating an electronic device 1000 according to embodiments, and FIG. 17 is a diagram illustrating an embodiment in which the electronic device 1000 of FIG. 16 is implemented as a smart phone.

Referring to FIGS. 16 and 17, an embodiment of the electronic device 1000 may include a processor 1010, a memory device 1020, a storage device 1030, an input/output (I/O) device 1040, a power supply 1050 and a display device 1060. The display device 1060 may be the display device 1 of FIG. 1. In addition, the electronic device 1000 may further include ports for communicating with a video card, a sound card, a memory card, a universal serial bus (USB) device, other electronic device, or the like.

In an embodiment, as illustrated in FIG. 17, the electronic device 1000 may be implemented as the smart phone. However, the electronic device 1000 is not limited thereto. For example, the electronic device 1000 may be implemented as a cellular phone, a video phone, a smart pad, a smart watch, a tablet personal computer (PC), a car navigation system, a computer monitor, a laptop computer, a head mounted display (HMD) device, or the like.

The processor 1010 may perform various computing functions. The processor 1010 may be a micro processor, a central processing unit (CPU), an application processor (AP), or the like. The processor 1010 may be coupled to other components via an address bus, a control bus, a data bus, or the like. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like.

The I/O device 1040 may include an input device such as a keyboard, a keypad, a mouse device, a touch-pad, a touch-screen, and the like, and an output device such as a printer, a speaker, or the like. In some embodiments, the display device 1060 may be included in the I/O device 1040.

The power supply 1050 may provide power for operations of the electronic device 1000.

The display device 1060 may be connected to other components through buses or other communication links.

The inventions may be applied to a display device and an electronic device including the display device, for example, a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A gate driver comprising:
an input circuit which transmits an input signal to a first control node based on a clock signal;
a control circuit which transmits a first power supply voltage to a third control node based on the input signal, and transmits the first power supply voltage to a second control node based on the first power supply voltage and a voltage of the third control node;
a first output circuit which outputs a gate signal having a second power supply voltage or a third power supply voltage based on a voltage of the first control node and a voltage of the second control node; and
a second output circuit which outputs a carry signal having the third power supply voltage or the first power supply voltage based on the voltage of the second control node, wherein the carry signal has a phase opposite to a phase of the gate signal.

2. The gate driver of claim 1, wherein the input circuit includes a first transistor including a control electrode which receives the clock signal, a first electrode which receives the input signal, and a second electrode connected to the first control node.

3. The gate driver of claim 2, wherein the control circuit includes:
a second transistor including a control electrode which receives the first power supply voltage, a first electrode connected to the third control node, and a second electrode connected to the second control node; and
a third transistor includes a control electrode which receives the input signal, a first electrode connected to the third control node, and a second electrode which receives the first power supply voltage.

4. The gate driver of claim 3, wherein the control circuit further includes:
a fourth transistor including a control electrode connected to the first control node, a first electrode which receives the third power supply voltage, and a second electrode connected to the third control node; and
a second capacitor including a first electrode which receives the third power supply voltage and a second electrode connected to the first control node.

5. The gate driver of claim 4, wherein the first output circuit includes:
a fifth transistor including a control electrode connected to the first control node, a first electrode which receives the third power supply voltage, and a second electrode connected to a first output node;
a sixth transistor including a control electrode connected to the second control node, a first electrode connected to the first output node, a second electrode which receives the second power supply voltage; and
a first capacitor including a first electrode connected to the second control node and a second electrode connected to the first output node.

6. The gate driver of claim 5, wherein the second output circuit includes:
a seventh transistor including a control electrode connected to the second control node, a first electrode which receives the third power supply voltage, and a second electrode connected to a second output node; and
an eighth transistor including a control electrode connected to the second control node, a first electrode connected to the second output node, and a second electrode which receives the first power supply voltage.

7. The gate driver of claim 6, wherein the third transistor and the eighth transistor are N-type transistors.

8. The gate driver of claim 7, wherein the first transistor, the second transistor and the fourth to seventh transistors are P-type transistors.

9. The gate driver of claim 6, wherein the third transistor further includes a second control electrode which receives a fourth power supply voltage.

10. The gate driver of claim 9, wherein a level of the fourth power supply voltage is lower than a level of the first power supply voltage.

11. The gate driver of claim 6, wherein the eighth transistor further includes a second control electrode connected to the control electrode of the eighth transistor.

12. The gate driver of claim 6, wherein a level of the first power supply voltage is lower than a level of the second power supply voltage, and
wherein a level of the third power supply voltage is higher than the level of the second power supply voltage.

13. The gate driver of claim 6, wherein a level of the first power supply voltage is higher than a level of the second power supply voltage, and
wherein a level of the third power supply voltage is higher than the level of the first power supply voltage.

14. A display device comprising:
a display panel including a pixel;
a gate driver which outputs a gate signal to the pixel;
a data driver which outputs a data voltage to the pixel; and
a driving controller which controls the gate driver and the data driver,
wherein the gate driver includes:
an input circuit which transmits an input signal to a first control node based on a clock signal;
a control circuit which transmits a first power supply voltage to a third control node based on the input signal, and transmits the first power supply voltage to a second control node based on the first power supply voltage and a voltage of the third control node;
a first output circuit which outputs the gate signal having a second power supply voltage or a third power supply voltage based on a voltage of the first control node and a voltage of the second control node; and
a second output circuit which outputs a carry signal having the third power supply voltage or the first power supply voltage based on the voltage of the second control node, wherein the carry signal has a phase opposite to a phase of the gate signal.

15. The display device of claim 14, wherein the input circuit includes a first transistor including a control electrode which receives the clock signal, a first electrode which receives the input signal, and a second electrode connected to the first control node.

16. The display device of claim 15, wherein the control circuit includes:
a second transistor includes a control electrode which receives the first power supply voltage, a first electrode connected to the third control node, and a second electrode connected to the second control node; and
a third transistor includes a control electrode which receives the input signal, a first electrode connected to the third control node, and a second electrode which receives the first power supply voltage.

17. The display device of claim 16, wherein the control circuit further includes:
a fourth transistor including a control electrode connected to the first control node, a first electrode which receives the third power supply voltage, and a second electrode connected to the third control node; and
a second capacitor including a first electrode which receives the third power supply voltage and a second electrode connected to the first control node.

18. The display device of claim 17, wherein the first output circuit includes:
a fifth transistor including a control electrode connected to the first control node, a first electrode which receives the third power supply voltage, and a second electrode connected to a first output node;
a sixth transistor including a control electrode connected to the second control node, a first electrode connected to the first output node, a second electrode which receives the second power supply voltage; and
a first capacitor including a first electrode connected to the second control node and a second electrode connected to the first output node.

19. The display device of claim 18, wherein the second output circuit includes:
a seventh transistor including a control electrode connected to the second control node, a first electrode which receives the third power supply voltage, and a second electrode connected to a second output node; and
an eighth transistor including a control electrode connected to the second control node, a first electrode connected to the second output node, and a second electrode which receives the first power supply voltage.

20. An electronic device comprising:
a processor which outputs an input control signal and input image data;
a display panel including a pixel;
a gate driver which outputs a gate signal to the pixel;
a data driver which outputs a data voltage to the pixel; and
a driving controller which controls the gate driver and the data driver based on the input control signal and the input image data,
wherein the gate driver includes:
an input circuit which transmits an input signal to a first control node based on a clock signal;
a control circuit which transmits a first power supply voltage to a third control node based on the input signal, and transmits the first power supply voltage to a second control node based on the first power supply voltage and a voltage of the third control node;
a first output circuit which outputs the gate signal having a second power supply voltage or a third power supply voltage based on a voltage of the first control node and a voltage of the second control node; and
a second output circuit which outputs a carry signal having the third power supply voltage or the first power supply voltage based on the voltage of the second control node, wherein the carry signal has a phase opposite to a phase of the gate signal.
